(19) United States
(12) Patent Application Publication
(10) Pub. No.: US 2025/0175779 A1
(43) Pub. Date: May 29, 2025

(54) SYSTEMS AND METHODS FOR IDENTIFYING AN EVENT

(71) Applicant: Zel Technologies, LLC, Hampton, VA (US)

(72) Inventors: Benjamin Eakins, Cape Canaveral, FL (US); Jack L. Ezzell, III, Alexandria, VA (US)

(73) Assignee: Zel Technologies, LLC, Hampton, VA (US)

(21) Appl. No.: 18/963,754

(22) Filed: Nov. 28, 2024

Related U.S. Application Data
(60) Provisional application No. 63/707,716, filed on Oct. 15, 2024.
(60) Provisional application No. 63/604,094, filed on Nov. 29, 2023.

(51) Int. Cl. H04W 4/90; H04W 4/029; H04W 4/38

(52) U.S. Cl. CPC H04W 4/90; H04W 4/029; H04W 4/38

(57) ABSTRACT

A decentralized event detection and geolocation system is disclosed, utilizing a dynamically adaptable Spontaneously Emergent Geolocation Network (SEGNet) comprising mobile, stationary, and other devices equipped with multi-sensor capabilities. The system operates by obtaining sensor data from distributed devices, applying trained models to detect potential events of interest (EOIs), and dynamically forming device networks for collaborative geolocation and event validation. The system employs synchronization mechanisms and geolocation techniques, including Time Difference of Arrival (TDOA) and/or Angle of Arrival (AoA), to determine event locations through multimodal data fusion and iterative validation processes. The architecture supports multiple operational modes, including decentralized, centralized, and hybrid configurations, enabling operation in connectivity-limited environments and enhanced processing when server access is available. The system is designed to accommodate dynamic task delegation and real-time threshold adjustments based on environmental conditions, providing reliable event detection and geolocation across diverse scenarios.

### CROSS-REFERENCE TO RELATED APPLICATIONS

This application claims priority to U.S. Provisional Application No. 63/604,094, entitled “SYSTEMS AND METHODS FOR IDENTIFYING AN EVENT,” filed Nov. 29, 2023, and U.S. Provisional Application No. 63/707,716, entitled “SYSTEMS AND METHODS FOR IDENTIFYING AN EVENT,” filed Oct. 15, 2024, each of which are incorporated herein by reference for all purposes.

### BACKGROUND

### Field of the Art

The systems and methods disclosed herein relate generally to event detection and, more specifically, to systems and methods for dynamically forming and managing decentralized sensor networks to detect, classify, and localize events of interest through multi-sensor data analysis and collaborative computational processes.

### Discussion of the State of the Art

The widespread adoption of smartphones has led to an unprecedented increase in the availability of sensor data. Modern smartphones are equipped with a variety of sensors, including microphones, GPS modules, accelerometers, gyroscopes, and barometers, which can capture diverse environmental and positional information. Additionally, these devices are capable of high-speed communication through cellular, Wi-Fi, and Bluetooth networks. Despite these capabilities, leveraging smartphone sensors for large-scale event detection and geolocation remains underdeveloped.

Traditional event detection and geolocation systems rely heavily on fixed sensor infrastructures, such as acoustic gunshot detection networks or seismic monitoring arrays. While these systems can provide accurate data in localized areas, they require significant investment in installation and maintenance. Moreover, their fixed nature limits their responsiveness to events occurring outside predefined monitoring zones.

Existing systems face challenges in noisy and dynamic environments, where conventional detection methods, such as matched filtering, struggle to maintain accuracy. These systems often operate under assumptions of idealized noise models, such as Additive White Gaussian Noise (AWGN). However, real-world environments are typically characterized by non-AWGN noise, including interference from overlapping signals, environmental clutter, and unpredictable human activity. This noise can degrade the performance of traditional detection methods, leading to high false alarm rates and missed detections.

Additionally, the computational requirements for accurate detection and geolocation often exceed the capabilities of conventional edge devices, such as smartphones. While some systems offload processing to centralized servers, this introduces latency and dependency on network availability. Furthermore, the continuous operation of sensors and communication modules on mobile devices can lead to significant battery drain, which discourages user participation in such systems.

Despite advancements in machine learning and sensor fusion techniques, current approaches often lack the adaptability and efficiency needed for real-time event detection across diverse environments. These systems are frequently optimized for specific use cases, limiting their applicability across different types of events or geographic regions. Moreover, privacy and security concerns arise when sensitive sensor data is transmitted to external servers for processing, highlighting the need for solutions that minimize data exposure while maintaining detection accuracy.

### SUMMARY

Systems and methods described herein address various deficiencies in existing event detection and geolocation systems by utilizing a decentralized and dynamically adaptable sensor network framework. In particular, the approaches described herein dynamically form and manage Spontaneously Emergent Geolocation Networks (SEGNets) using mobile, stationary, stand-alone specialized devices, or a combination thereof, equipped with multi-sensor capabilities to detect and geolocate sound-based events.

In an embodiment, the stand-alone specialized devices can be pre-installed at specified geo-locations and are designed to detect and process acoustic signals associated with firearms. These devices may include, but are not limited to, acoustic sensors, microphones, and digital signal processors. The stand-alone devices can operate independently and/or can connect to existing security cameras and monitor streaming video feeds for firearms and/or the mesh network associated with mobile phones as described below. When connected to security cameras and/or mesh networks, the stand-alone devices can use image recognition algorithms to detect the presence of firearms in the video feed and correlate this information with the acoustic data to improve the accuracy of gunshot detection.

In an embodiment, SEGNets can enable the detection, classification, and localization of Events of Interest (EOIs) through collaborative computational processes, dynamic threshold adjustments, and multi-sensor data fusion techniques. Collaborative computational processes within SEGNets include the distribution of data processing tasks among participating devices, leveraging their collective computational resources. For instance, one device may perform initial signal filtering, while another executes geolocation algorithms. This division of work reduces the computational burden on individual devices and enhances the overall efficiency and responsiveness of the network.

In various embodiments, the system employs a dynamic network formation module operable to activate SEGNets upon detecting an EOI. The SEGNets operate in several modes, including, for example, a decentralized mode in which participating mobile devices collaboratively perform geolocation and event detection without requiring a centralized server. Alternatively, in centralized or hybrid modes, devices transmit sensor data to a remote detection system, such as a cloud server, for computationally intensive geolocation, event validation, or resource optimization. In certain embodiments, stationary devices, such as fixed hubs, beacons, or edge servers, may be incorporated within the SEGNet to facilitate data exchange, enhance network stability, or provide additional geolocation support in challenging environments.

In an embodiment, the system includes a lead device selection mechanism operable to dynamically assign one device within the SEGNet as the lead. This lead device coordinates sensor data aggregation, task delegation, and geolocation computations, thereby optimizing resource utilization while minimizing latency. The lead device may process multimodal sensor data locally to validate an event and determine its geolocation, while subsequent verifications or processing tasks are offloaded to a remote server when connectivity is available. In certain embodiments, the lead device transitions seamlessly between local and server-based operations depending on real-time network conditions.

In certain embodiments, the system includes a dynamic threshold adjustment mechanism that adapts detection thresholds in response to environmental conditions, resource constraints, or event characteristics. The threshold mechanism processes real-time inputs, such as noise levels, device density, or signal interference, dynamically refining detection criteria to mitigate false alarms while maintaining sensitivity to true EOIs. Threshold adjustments are implemented through a combination of machine learning-based prediction models and rule-based systems. For instance, in a dense urban environment with significant ambient noise, thresholds for audio-based detections are increased to reduce false positives. Conversely, in quieter rural areas, thresholds are lowered to detect subtler events. The system periodically recalibrates these thresholds using environmental data collected during SEGNet operations, ensuring adaptability to diverse conditions. The system leverages lightweight neural networks and multimodal correlation techniques to distinguish relevant event patterns from background noise and environmental disturbances.

In an embodiment, the system integrates a neural network-based signal correlation and filtering component with a Constant False Alarm Rate (CFAR) detection algorithm to maintain detection accuracy under complex environmental conditions. The CFAR detector dynamically adjusts thresholds to process sensor data across varying noise levels, while the neural network-based correlation module aligns multimodal inputs for robust validation. Sensor fusion techniques further enhance reliability by combining diverse sensor data streams, such as audio signals, accelerometer readings, barometric pressure data, and gyroscopic outputs, ensuring detection accuracy across a wide range of scenarios.

The described SEGNets adaptively transition between operational modes to address varying system requirements. In scenarios where connectivity to the remote detection system is unavailable, the SEGNet operates autonomously, with participating devices collaboratively detecting and geolocating EOIs. When connectivity is restored, the system augments local processing with server-based computations to refine results and provide enhanced geolocation accuracy. Furthermore, the system dynamically distributes processing loads among networked devices to optimize resource consumption and minimize latency.

Advantageously, the systems and methods disclosed herein provide a scalable and resource-efficient framework for decentralized event detection and geolocation. By leveraging existing mobile device sensors and computational capabilities, the system reduces reliance on fixed sensor infrastructures while maintaining robust detection accuracy. The decentralized architecture ensures reliable operation in resource-constrained and connectivity-limited environments, while privacy is preserved through localized data processing and event validation.

Various other functions and advantages are described and suggested below as may be provided in accordance with the various embodiments.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates an exemplary system architecture for a Spontaneously Emergent Geolocation Network (SEGNet) in accordance with various embodiments.

FIG. 2 illustrates an exemplary configuration of components for a detection application and a detection system in accordance with various embodiments.

FIG. 3 provides a detailed view of a detection system in accordance with various embodiments.

FIG. 4 illustrates an exemplary neural network training pipeline in accordance with various embodiments.

FIG. 5 illustrates an example process for determining training data that can be utilized in accordance with various embodiments.

FIG. 6 illustrates an example process for training a model that can be utilized in accordance with various embodiments.

FIG. 7A illustrates an exemplary SEGNet formation and geolocation workflow using device-based processing in accordance with various embodiments.

FIG. 7B illustrates an exemplary SEGNet formation and geolocation workflow using server-based processing in accordance with various embodiments.

FIG. 7C illustrates an exemplary SEGNet formation and geolocation workflow using server-based processing with an external desktop interface in accordance with various embodiments.

FIG. 7D illustrates an exemplary SEGNet formation and geolocation workflow utilizing dual workload processing between SEGNet devices and a remote server in accordance with various embodiments.

FIG. 8 illustrates an exemplary process for detecting, identifying, and geolocating Events of Interest (EOIs) within a SEGNet in accordance with various embodiments.

FIG. 9 illustrates an exemplary process of analyzing data for Event of Interest (EOI) detection in accordance with various embodiments.

FIG. 10 illustrates an exemplary process for validating data sufficiency within a SEGNet in accordance with various embodiments.

FIG. 11 illustrates an exemplary process for performing geolocation processing within a SEGNet in accordance with various embodiments.

FIG. 12 illustrates an exemplary process for multi-sensor detection and data fusion within a SEGNet in accordance with various embodiments.

FIG. 13 illustrates an exemplary process for neural network-based data correlation and detection within a SEGNet in accordance with various embodiments.

FIG. 14A illustrates a front view of an electronic device in accordance with an embodiment.

FIG. 14B illustrates a back view of an electronic device in accordance with an embodiment.

FIG. 15 illustrates one embodiment of the computing architecture that supports an embodiment of the inventive disclosure.

FIG. 16 illustrates components of a system architecture that supports an embodiment of the inventive disclosure.

FIG. 17 illustrates components of a computing device that supports an embodiment of the inventive disclosure.

FIG. 18 illustrates components of a computing device that supports an embodiment of the inventive disclosure.

### DETAILED DESCRIPTION

The embodiments described herein relate to systems and methods for dynamically forming and managing decentralized sensor networks for detecting, classifying, and geolocating events of interest (EOIs). The system is operable to utilize multi-sensor data from devices such as mobile phones, stationary hubs, and other networked devices to collaboratively process and analyze event-related information. In various embodiments, the system applies techniques such as Time Difference of Arrival (TDOA) and/or Angle of Arrival (AOA) to determine the geolocation of detected events. In certain embodiments, the system operates across different modes, including device-to-device communication within a mesh network and data transmission to a remote detection system for centralized processing. The system is further configured to manage dynamic thresholds for event detection, optimizing resource usage while maintaining reliable detection across varying environmental conditions.

### Conceptual Architecture

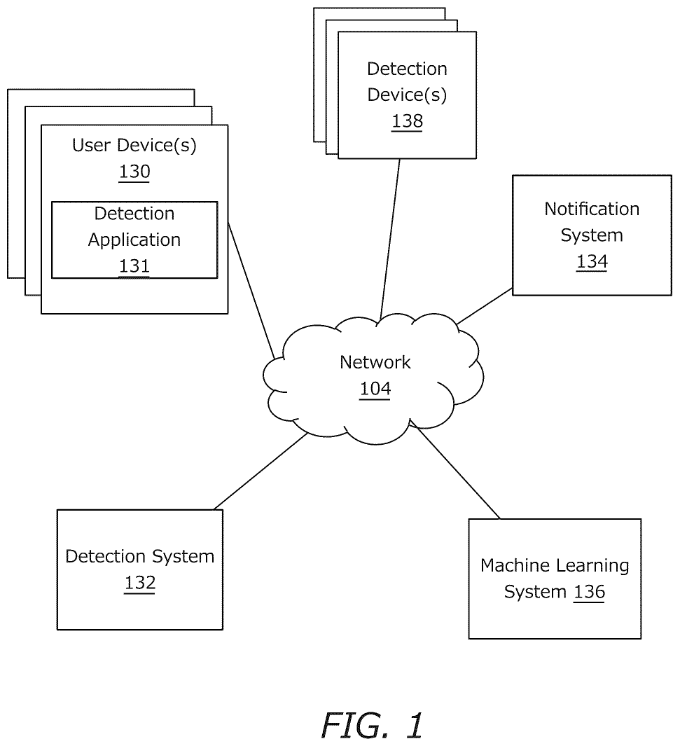

FIG. 1 illustrates the network architecture for a decentralized event detection and geolocation system in accordance with various embodiments. In this embodiment, the system comprises user device(s) 130, detection system 132, detection device(s) 138, notification system 134, machine learning system 136, and a network 104, over which the various systems and devices communicate and interact. The components in this architecture interact to enable the detection, classification, and geolocation of events of interest (EOIs) using a combination of local and/or remote computational resources.

The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met.

Detection system 132 is operable to receive and process event-related data transmitted from user devices 130. This system may include components for signal processing, sensor data aggregation, and geolocation computation. In some embodiments, detection system 132 operates as a centralized hub for consolidating data from multiple devices and applying computationally intensive algorithms, such as Time Difference of Arrival (TDOA) and/or Angle of Arrival (AOA) calculations, to precisely geolocate events.

Notification system 134 disseminates event-related alerts and geolocation information to authorized users and third-party systems, such as emergency responders. In some embodiments, notification system 134 operates from a remote server; in others, it may function locally on a primary participant device within the SEGNet, such as the device closest to the detected event.

Notification system 134 may operate from a centralized server, providing a global view of detected events and ensuring efficient dissemination of alerts across a broad user base. In this configuration, the system aggregates event data from multiple SEGNets and transmits notifications to relevant stakeholders based on predefined criteria, such as proximity to the event or assigned roles (e.g., emergency personnel, facility managers).

In an embodiment, notification system 134 can function locally within a SEGNet, utilizing a primary participant device to coordinate notifications. This primary participant device, which may be the device closest to the detected event, is operable to issue alerts directly to nearby users and systems. This localized operation mode is particularly advantageous in scenarios where network connectivity to the remote server is limited or unavailable, ensuring timely dissemination of critical information.

In certain embodiments, notification system 134 includes a prioritization module operable to classify events based on severity, type, and urgency. For example, high-priority events such as explosions, gunshots, or hazardous material releases may trigger immediate notifications to emergency responders, while lower-priority events might only notify specific user groups. The prioritization module ensures that recipients receive relevant and timely information based on their roles and proximity to the event.

Notification system 134 is further configured to support multi-channel communication. In various embodiments, the system can send alerts through mobile applications, SMS, email, or automated voice calls. For instance, first responders might receive detailed alerts through a dedicated mobile application, while community members within a specified radius might receive SMS alerts providing safety instructions.

The notification system is operable to integrate with third-party systems, such as public safety networks, emergency dispatch systems, or facility management platforms, through standardized APIs or data exchange protocols. This integration allows for seamless coordination and response by enabling third-party systems to access real-time event data and geolocation information directly from notification system 134.

In certain embodiments, notification system 134 includes a user preferences module that allows authorized users to customize notification settings. Users can specify the types of events they wish to be notified about, preferred communication channels, and notification frequency. For example, a facility manager might choose to receive all alerts related to their premises, while a general user might only opt in for high-priority safety alerts.

Notification system 134 may also include an acknowledgment and feedback component, allowing recipients to confirm receipt of notifications or provide additional information about the event. This feedback can be used to update the event status, refine geolocation accuracy, or enhance situational awareness for responders.

In some embodiments, notification system 134 supports the dissemination of multimedia content, such as images, videos, or audio recordings captured by participating devices. For example, video footage from a user device near the event could be shared with responders to provide visual confirmation and context.

Machine learning system 136 is operable to train and refine detection algorithms using historical event data. This system may include modules for signal filtering, dynamic threshold adjustment, and predictive analytics to improve the accuracy and efficiency of event detection and geolocation over time. In certain embodiments, machine learning system 136 processes data locally on user devices, enhancing privacy and reducing the need for continuous network connectivity.

User device(s) 130 represents any computing device operable to collect, process, and transmit data over network 104. These devices can be used to facilitate real-time interaction, data collection, and communication with other system components, such as detection system 132 and machine learning system 136. User device(s) 130 include, but are not limited to, mobile phones, tablets, laptops, desktop computers, and other computing devices equipped with hardware, software, or embedded logic components.

In certain embodiments, user device(s) 130 leverage built-in multi-sensor capabilities, such as microphones, accelerometers, gyroscopes, and GPS modules, to detect and capture event-related data. These sensors enable user device(s) 130 to perform functions within Spontaneously Emergent Geolocation Networks (SEGNets), including local data analysis, event detection, and geolocation computations. Depending on the implementation, user device(s) 130 may operate autonomously or in collaboration with other devices within the SEGNet to optimize the system's performance.

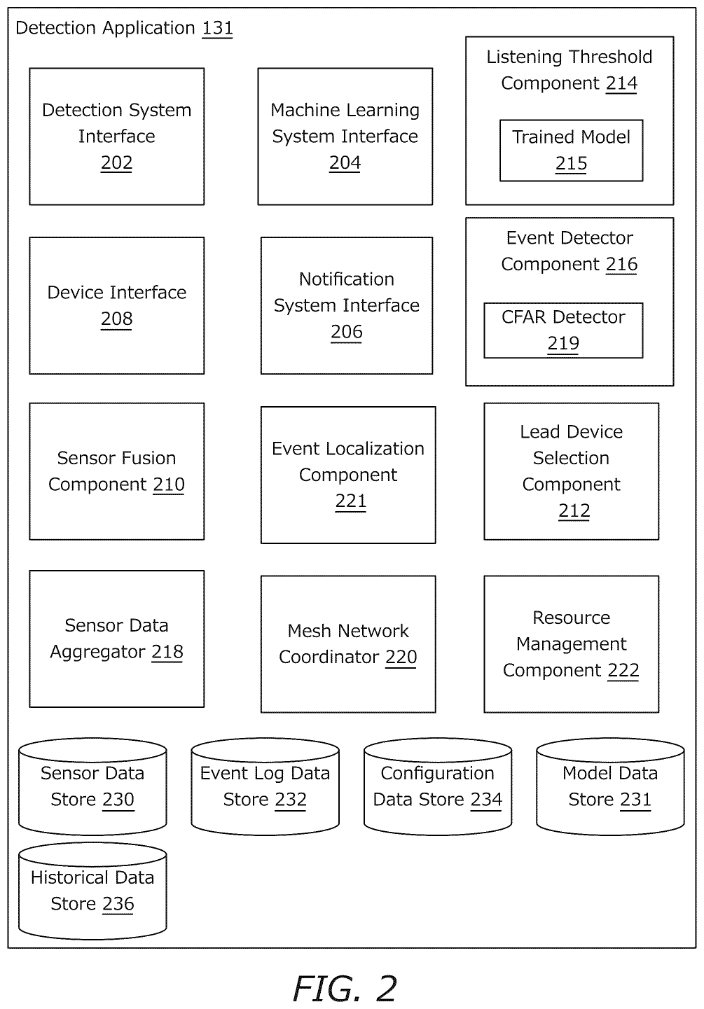

User device(s) 130 are configured to execute detection application 131, which facilitates event detection, data collection, and communication within the SEGNet framework. Detection application 131 is operable to continuously monitor data streams from the device's sensors and apply detection algorithms to identify potential events of interest (EOIs). In certain embodiments, a ‘potential event’ is identified through the use of trained models that classify sensor data based on predefined criteria. For instance, sensor data patterns indicative of gunshots, explosions, or seismic activity may be extracted through feature engineering techniques, such as spectrogram analysis for audio signals and accelerometer spike detection. The detection system leverages multimodal sensor inputs to correlate diverse environmental signals and isolate patterns associated with potential events. Upon detecting an EOI, detection application 131 initiates data sharing and collaboration with other devices in the SEGNet, transmitting event-related data for further analysis and geolocation computations. Detection application 131 is further described in FIG. 2.

Detection application 131 may also dynamically adjust its behavior based on system requirements and environmental conditions. In an embodiment, ‘environmental conditions’ as described herein may include dynamic and measurable factors influencing sensor data or system operations. For instance, environmental conditions may encompass noise levels, physical obstructions, signal interference, or weather variations. These factors are assessed in real time, and the system applies adaptive techniques to mitigate potential disruptions while maintaining the accuracy of detection and geolocation processes. Adjusting behavior based on system requirements and environmental conditions can include, for example, applying adaptive thresholding techniques to reduce false positives or optimize sensor usage to conserve device resources. In certain embodiments, detection application 131 incorporates security features, such as encryption and authentication protocols, to ensure the integrity and confidentiality of the data transmitted over the network.

User device(s) 130 can execute additional applications, including web-based interfaces accessed through web browsers like MICROSOFT EDGE, GOOGLE CHROME, and MOZILLA FIREFOX, or locally installed applications designed for secure interaction with the system. These applications enable users to visualize event data, adjust system configurations, and monitor the network's operational status. The system supports both real-time and asynchronous data interactions, allowing user device(s) 130 to remain functional even in varying network conditions.

In various embodiments, user device(s) 130 are operable to dynamically switch between operational modes based on network availability and system requirements. For instance, in a peer-to-peer mode, user devices collaborate directly with each other for event detection and geolocation without requiring a centralized server. In scenarios with network connectivity, user devices may transmit data to remote systems for more complex analysis and verification. Detection device(s) 138 can refer to stationary computing devices that function as fixed nodes within the SEGNet. These devices may include hubs, beacons, or other stationary units equipped with sensor arrays and communication modules. Detection device(s) 138 enhances the network's stability by providing additional data points, facilitating sensor data aggregation, and relaying information to mobile devices or remote systems.

In an embodiment, detection device(s) 138 can be deployed in fixed locations, such as urban environments or infrastructure sites, to supplement mobile device capabilities. These devices are operable to capture and process sensor data, including audio, vibration, and environmental metrics, which are then used for event detection and geolocation. Detection device(s) 138 may also serve as communication relays, ensuring data continuity in areas with limited mobile coverage.

In other embodiments, detection device(s) 138 may include stand-alone specialized devices designed for detecting gunshots or other sound-based events. These stand-alone devices can be pre-installed at specified geo-locations and equipped with sensors such as acoustic sensors, microphones, video cameras, infrared sensors, and digital signal processors. These devices may be powered by batteries, solar panels, or other suitable power sources and can communicate with the system via wired or wireless connections, such as Wi-Fi, Bluetooth, or cellular networks. For instance, the stand-alone devices may continuously monitor indoor or outdoor environments, such as buildings, streets, or parks, for gunshots or other sound-based events. Upon detection, they are configured to transmit relevant data, such as audio recordings, video footage, and/or sensor readings, to the system for further analysis and geolocation.

In certain embodiments, the stand-alone specialized devices may also include network connectivity modules that enable communication with other devices, a server, or a mesh network. These devices may connect to existing security cameras and monitors streaming video feeds for firearms. When connected, the devices can use image recognition algorithms to detect the presence of firearms in the video feed and correlate this information with the acoustic data to improve the accuracy of gunshot detection. These devices provide complementary monitoring capabilities that enhance the overall detection and geolocation processes by integrating multiple data streams.

Detection device(s) 138 can include embedded logic components for local data processing and analysis. In certain embodiments, these devices are operable to perform preliminary event classification and geolocation tasks, reducing the computational load on user device(s) 130. For example, synchronized audio and video data may be processed locally to confirm the presence of a firearm or other Event of Interest (EOI) before transmitting relevant data to remote systems. Detection device(s) 138 may also operate as gateways, transmitting aggregated data to remote systems for further processing and long-term storage.

Network 104 facilitates data exchange between various components and devices within the system, including user device(s) 130, detection device(s) 138, detection system 132, and remote server-based systems. This network architecture enables both real-time and asynchronous data communication, ensuring that event data, geolocation results, and system updates are transmitted efficiently and reliably. Network 104 is operable to support diverse communication protocols and can adapt to varying network conditions to maintain seamless interactions among system components.

In certain embodiments, network 104 encompasses a range of network configurations, including but not limited to local area networks (LANs), wide area networks (WANs), virtual private networks (VPNs), and wireless networks such as Wi-Fi, 4G, 5G, and satellite communications. These configurations enable the system to operate in various environments, from densely populated urban areas to remote locations with limited infrastructure. Network 104 can utilize hybrid networking approaches, combining wired and wireless connections to optimize data transmission and system performance.

One or more links connect each system, module, or device to network 104, facilitating communication through wired, wireless, or optical connections. These links may include Ethernet, fiber-optic cables, Wi-Fi, Bluetooth, or cellular networks, depending on the specific requirements of the system and the deployment environment. In various embodiments, network 104 is operable to prioritize data traffic based on system-critical operations, ensuring that high-priority data, such as event detection and geolocation information, is transmitted with minimal latency.

The network architecture supports the system's scalability by allowing the addition of new components, such as additional user device(s) 130, detection device(s) 138, or machine learning nodes, without requiring significant reconfiguration. This modularity enables the system to expand dynamically in response to increased operational demands or changes in deployment scenarios. For example, new detection devices can be seamlessly integrated into the SEGNet to enhance coverage and improve event detection accuracy.

In various embodiments, network 104 includes mechanisms for secure data transmission. These mechanisms may involve encryption protocols, such as Transport Layer Security (TLS) or Advanced Encryption Standard (AES), to protect data in transit. Additionally, authentication mechanisms, including multi-factor authentication (MFA) and public key infrastructure (PKI), ensure that only authorized devices and users can access the system. The network may also implement intrusion detection systems (IDS) and firewalls to safeguard against unauthorized access and cyber threats.

Network 104 is operable to support data synchronization across distributed components, enabling the system to maintain consistent and accurate event data, geolocation results, and operational metrics. In scenarios where network connectivity is intermittent or unavailable, the system can store data locally on user device(s) 130 or detection device(s) 138 and synchronize it with remote systems once connectivity is restored. This capability ensures data continuity and system reliability across diverse operational environments.

In certain embodiments, network 104 may also support edge computing, where data processing and analysis are performed closer to the data source (e.g., on user or detection devices) to reduce latency and optimize resource usage. This distributed processing model enhances the system's responsiveness and allows real-time decision-making at the edge, while still enabling comprehensive analysis and storage on centralized servers when necessary.

The present disclosure contemplates that network 104 may be designed with redundancy and failover mechanisms to ensure high availability and minimize downtime. These mechanisms include redundant communication links, automatic failover to backup systems, and load balancing across network resources. Such features enhance the system's resilience and ensure continuous operation even in the event of network disruptions or component failures.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to client/user devices or other devices in response to HTTP or other requests from client devices or other devices. A mail server is generally capable of providing electronic mail services to various client devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In a particular embodiment, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

FIG. 2 illustrates an exemplary embodiment of detection application 131, operable within user device(s) 130 or other appropriate devices in accordance with various embodiments. Detection application 131 comprises several interfaces, including a detection system interface 202, machine learning system interface 204, notification system interface 206, and device interface 208, which facilitate communication with external systems. Additionally, detection application 131 incorporates event data store 232 and configuration data store 234 to support real-time and historical data management. Detection functionalities are performed by various components, including listening threshold component 214, which includes trained model 215; event detector component 216, which includes CFAR detector 219; sensor fusion component 210; event localization component 221; lead device selection component 212; sensor data aggregator 218; mesh network coordinator 220; and resource management component 222. Each of these components collaborates to enable event detection, localization, and data management within Spontaneously Emergent Geolocation Networks (SEGNets).

Detection system interface 202 is operable to manage communication and data exchange between detection application 131 and detection system 132. More specifically, detection system interface 202 facilitates the structured transmission of event-related data, including raw audio, timestamp data, geolocation information, and sensor data such as barometric pressure, gyroscopic readings, magnetometer data, accelerometer data, and image data captured during event detection, from user device(s) 130 to detection system 132 for further analysis.

For example, detection system interface 202 formats and transmits multi-sensor data in a manner compatible with the detection algorithms within detection system 132. Timestamp data is leveraged to synchronize sensor readings, while geolocation data assists in spatial analysis of the detected events. In certain embodiments, detection system interface 202 is operable to perform initial data validation, ensuring the consistency and completeness of the transmitted data set.

In various embodiments, detection system interface 202 supports bidirectional communication, enabling detection system 132 to return event detection results, refined geolocation data, or operational status updates to detection application 131. For instance, upon receiving confirmation of an event or a refined geolocation estimate, detection system interface 202 relays this information to event detector component 216 within detection application 131 for further processing and user notification.

Detection system interface 202 supports a variety of communication protocols, such as gRPC, REST API, or lightweight messaging protocols like MQTT, based on the network environment. These protocols are configured to enable the efficient and reliable transfer of large datasets, such as high-resolution audio and image files, while maintaining low latency.

In certain embodiments, detection system interface 202 supports asynchronous data transmission, allowing sensor data to be queued locally on the user device when network connectivity is limited. Once network conditions improve, the queued data is transmitted to detection system 132, ensuring that critical event data is preserved for further analysis.

Machine learning system interface 204 is operable to facilitate communication between detection application 131 and machine learning system 136. More specifically, machine learning system interface 204 manages the transmission of event-related data collected by detection application 131, including sensor-derived data such as audio, location coordinates, barometric pressure, gyroscopic readings, magnetometer data, accelerometer data, and image captures. This data is utilized by machine learning system 136 for model retraining, refinement, and validation.

For example, machine learning system interface 204 is configured to preprocess sensor data prior to transmission. This preprocessing may include data compression, encoding, and error-checking to ensure efficient and reliable transfer. In certain embodiments, the interface transmits timestamped sensor data, facilitating accurate temporal alignment and synchronization during model updates within machine learning system 136.

In an embodiment, machine learning system interface 204 is operable to retrieve updated model parameters or fully trained models from machine learning system 136. These models are then deployed back into detection application 131 to improve its event detection and classification capabilities. The interface may also manage version control to ensure that the latest and most optimized model versions are consistently utilized across all participating devices in the network.

In various configurations, machine learning system interface 204 employs secure communication protocols, such as gRPC, HTTPS, or message queue protocols, to maintain data integrity and confidentiality during transmission. These protocols are configured to safeguard sensitive data, including geolocation and sensor data, ensuring secure interactions between detection application 131 and machine learning system 136.

In certain embodiments, machine learning system interface 204 supports asynchronous communication, enabling detection application 131 to continue its event detection and data collection operations independently of machine learning system 136's response times. This capability ensures uninterrupted system functionality, even in scenarios with limited or intermittent network connectivity.

Additionally, machine learning system interface 204 is operable to aggregate performance feedback from machine learning system 136. This feedback loop allows detection application 131 to dynamically adjust its detection thresholds and operational parameters in real-time, optimizing performance based on evolving environmental conditions and data trends.

Notification system interface 206 is operable to facilitate the transmission of event-related notifications and geolocation data from detection application 131 to notification system 134. More specifically, notification system interface 206 transmits event confirmation data, including sensor metadata such as audio recordings, location coordinates, barometric pressure, gyroscopic readings, magnetometer data, accelerometer data, and image captures, to authorized users and third-party systems via notification system 134.

For example, notification system interface 206 is configured to transmit alerts indicating the occurrence of a detected event of interest (EOI), accompanied by geolocation information, to relevant entities such as emergency response teams or monitoring centers. The interface formats and encapsulates event data to ensure compatibility with various notification delivery methods, including SMS, email, push notifications, or API-based integrations with external systems.

In an embodiment, notification system interface 206 includes mechanisms for prioritizing notifications based on criteria such as event type, severity, or proximity to critical locations. For instance, high-priority events, such as confirmed explosions or gunshots, may prompt immediate notifications to nearby devices or predesignated contacts, while lower-priority events are queued for delayed or batch processing.

Notification system interface 206 employs secure communication protocols, including HTTPS and MQTT, to safeguard the integrity and confidentiality of transmitted data. Additionally, the interface may implement encryption techniques and authentication protocols to prevent unauthorized access to sensitive event information.

In certain embodiments, notification system interface 206 supports bidirectional communication, enabling notification system 134 to receive acknowledgments or feedback from recipients. This feedback loop allows for the confirmation of notification delivery, updates to event statuses, or the submission of additional contextual data, such as user-reported observations about the detected event.

Notification system interface 206 is also operable to facilitate real-time or near-real-time communication with other system components. For instance, it can relay updates from machine learning system 136 to end users, informing them of modifications to detection parameters or the deployment of new models that may affect event notification criteria.

Device interface 208 is operable to manage communication between detection application 131 and various external devices participating within the Spontaneously Emergent Geolocation Network (SEGNet). More specifically, device interface 208 facilitates the exchange of sensor data, operational commands, and event-related information among user device(s) 130, detection devices 138, and other interconnected devices within the system.

For example, in an embodiment, device interface 208 transmits raw and processed sensor data, including but not limited to audio recordings, location coordinates, barometric readings, gyroscope and accelerometer data, magnetometer data, image captures, and timestamp information, between SEGNet devices. This data sharing enables collaborative event validation and synchronized geolocation computations across multiple devices. Device interface 208 is operable to streamline inter-device coordination, ensuring that devices can exchange sensor inputs and operate collectively to enhance event detection accuracy.

Device interface 208 supports both direct device-to-device communication and indirect communication via network 104. In a direct communication mode, device interface 208 utilizes short-range communication protocols such as Bluetooth, Wi-Fi Direct, or Zigbee to establish peer-to-peer connections between SEGNet devices. In a networked mode, the interface uses internet-based protocols, including TCP/IP or WebSocket, to facilitate data transmission through centralized or distributed network infrastructures.

In certain embodiments, device interface 208 is operable to manage device discovery and session initiation within the SEGNet. Upon detecting an Event of Interest (EOI), the interface initiates contact with nearby devices to establish a temporary network for data exchange and collaborative analysis. During this process, device interface 208 negotiates connection parameters, such as encryption keys, communication channels, and data transmission rates, to optimize network performance and ensure data security.

Device interface 208 is also operable to relay operational commands issued by the lead device within the SEGNet to other participating devices. For instance, the lead device may send commands to dynamically adjust listening thresholds, activate or deactivate specific sensors, or prioritize certain data streams based on event characteristics and prevailing network conditions. In various embodiments, device interface 208 incorporates error-checking and

synchronization mechanisms to maintain data integrity and consistency across the network. These mechanisms detect and correct transmission errors, align timestamp data from different devices, and aggregate multi-sensor inputs for cohesive event analysis. This ensures that all devices within the SEGNet operate using a synchronized dataset, thereby enhancing the accuracy and reliability of event detection and geolocation processes.

Listening threshold component 214 is operable to dynamically filter and prioritize incoming sensor data streams to identify potential Events of Interest (EOIs). More specifically, this component leverages trained model 215, which may comprise a lightweight neural network or other machine learning models, to analyze multi-sensor data in real-time and adaptively adjust detection thresholds based on environmental conditions and historical patterns.

For example, listening threshold component 214 processes audio signals captured by the device's microphone, identifying frequency spikes or waveform patterns associated with specific events, such as gunshots, explosions, or breaking glass. Simultaneously, the component monitors accelerometer and gyroscopic data for abrupt changes in motion or orientation that may indicate seismic activity, impact events, or structural anomalies.

In an embodiment, trained model 215 is pre-trained on diverse datasets containing both EOI and non-EOI scenarios. The model transforms real-time sensor inputs into a new representation, suppressing non-EOI data and amplifying EOI data. In an alternative embodiment, a dynamic thresholding component may be utilized to adjust detection thresholds in response to environmental conditions. For instance, in a noisy urban environment, the thresholds for audio-based triggers may be elevated to filter out background noise, while in a quieter rural setting, the thresholds may be lowered to detect subtler sound cues.

Listening threshold component 214 operates in conjunction with sensor fusion component 210, enabling multi-sensor correlation. For example, if the primary sensor (e.g., microphone) detects a potential EOI, data from secondary sensors (e.g., accelerometer and barometer) is analyzed to confirm or discard the event. This multi-sensor approach reduces false positives and enhances detection robustness, especially in environments with high background noise or variable conditions.

In certain embodiments, listening threshold component 214 employs dynamic thresholding algorithms that adapt based on feedback from machine learning system 136. For instance, if the system detects an increase in false positives over time, it can adjust the thresholds accordingly, optimizing performance without manual intervention. Additionally, these thresholds may be recalibrated periodically using updated models received from machine learning system 136 via machine learning system interface 204.

In certain embodiments, listening threshold component 214 leverages various preprocessing techniques to enhance the accuracy and efficiency of event detection. For example, audio signals may be preprocessed using wavelet transforms to decompose the signal into time-frequency representations. These representations are then analyzed by trained model 215 to isolate event-specific frequency patterns. For motion data, principal component analysis (PCA) can be applied to identify the principal axes of movement, distinguishing between regular device motion, such as walking, and abrupt changes indicative of EOIs. Additionally, the system dynamically adjusts sensitivity ranges for each sensor type through dynamic range adaptation, which accounts for environmental conditions such as varying ambient light for optical sensors or air pressure for barometric sensors. These preprocessing techniques enable listening threshold component 214 to optimize detection capabilities across diverse scenarios and environmental conditions.

In accordance with various embodiments, to address the limited computational resources and battery life of participating devices, listening threshold component 214 incorporates a two-step detection process. In the first step, the component uses a fast and computationally efficient Constant False Alarm Rate (CFAR) detector as a trigger mechanism to identify potential EOIs. This detector eliminates unnecessary resource consumption by filtering out low-probability events, significantly reducing the load on the device during periods of SEGNet inactivity. For instance, the CFAR detector may analyze audio signals for rapid amplitude spikes or abrupt frequency changes that meet a predefined minimum confidence level. In the situation where this initial threshold is surpassed does the system activate the second step.

In the second step, listening threshold component 214 employs trained model 215 and more computationally intensive preprocessing methods, such as likelihood-ratio tests or neural network analysis, to validate the detected event. This validation ensures that only high-probability EOIs trigger the activation of the SEGNet and subsequent resource-intensive operations, such as multi-device data transmission or geolocation processing. For example, after an initial CFAR detection, additional sensor inputs, such as accelerometer data, are processed to confirm the EOI before forming the SEGNet.

Listening threshold component 214 is also configured to initiate SEGNet activation when a validated EOI is confirmed. The system transitions from low-power monitoring to full-scale network operations, activating resource-intensive components, such as sensor fusion component 210 and event detector component 216, only when necessary. This dynamic activation strategy ensures efficient resource utilization across all devices in the SEGNet.

Event detector component 216 is operable to analyze preprocessed sensor data to identify Events of Interest (EOIs). More specifically, event detector component 216 applies various signal detection algorithms, including a Constant False Alarm Rate (CFAR) detector 219, to distinguish between normal background activity and potential EOIs. This component serves as the decision-making unit for confirming whether an event meets the criteria for further analysis and localization.

In certain embodiments, CFAR detector 219 processes audio data by detecting anomalies in signal amplitude, frequency, or time domain that correspond to specific EOIs, such as gunshots, explosions, or other impulsive sounds. For instance, CFAR detector 219 may utilize a sliding window approach, calculating signal-to-noise ratios (SNR) for each window. When the SNR exceeds dynamically adjusted detection thresholds, an event is flagged for further validation.

Event detector component 216 incorporates detection methods, including frequency-domain analysis, dynamic noise estimation, and multi-sensor correlation. Frequency-domain analysis leverages Fast Fourier Transform (FFT) to convert time-domain audio signals into their frequency-domain representation, identifying characteristic frequency spikes associated with specific events. For dynamic noise estimation, CFAR detector 219 continuously monitors and adapts to varying noise conditions, ensuring a consistent false alarm rate. This is particularly effective in diverse environments, such as urban areas with high ambient noise or rural areas with minimal interference. In multi-sensor correlation scenarios, event detector component 216 evaluates correlations across different sensor streams (e.g., audio and accelerometer data). When anomalies are detected simultaneously across these streams, the likelihood of an EOI increases, improving detection reliability.

In an embodiment, event detector component 216 operates in coordination with listening threshold component 214 to refine detection accuracy. Data passing the initial thresholds is further processed using more computationally intensive techniques, such as spectrogram analysis, envelope detection, or machine learning classifiers. In some configurations, CFAR detector 219 extends its capabilities beyond audio data to handle other sensor inputs, including accelerometer motion patterns, barometric pressure changes, or gyroscope readings. For example, a sudden drop in barometric pressure, combined with a high-frequency audio spike, may indicate an explosion event.

Event detector component 216 is operable to flag confirmed EOIs for subsequent geolocation and classification by event localization component 221. Additionally, raw and processed sensor data associated with confirmed EOIs are archived in event data store 232 for validation, auditing, or training purposes. In certain embodiments, event detector component 216 integrates with machine learning models that enhance its detection algorithms. These models, retrained periodically using new data from machine learning system 136, ensure that the system adapts to emerging event types and varying environmental conditions.

The event detector component 216 also provides confidence scores for each detection, which can be used by resource management component 222 to allocate computational resources dynamically. For example, high-confidence detections might trigger immediate geolocation processing, while low-confidence detections might be queued for further validation to conserve device resources.

In certain embodiments, event detector component 216 employs a tiered detection strategy to optimize both resource efficiency and detection accuracy. The first tier uses lightweight detection algorithms, such as energy-based thresholds or simple envelope detection, to screen incoming sensor data for anomalies indicative of EOIs. For example, this tier may detect a sudden spike in audio amplitude or abrupt motion patterns captured by accelerometers. When these preliminary thresholds are met, the system escalates to a second tier of more advanced analysis, such as spectrogram analysis, time-frequency decomposition, or machine learning classifiers, to confirm and classify the potential EOI.

To address the challenges of resource constraints on mobile devices, event detector component 216 leverages distributed processing between detection application 131 and detection system 132. The initial anomaly detection and feature extraction are performed locally on participating mobile devices, while more computationally intensive tasks, such as likelihood ratio tests or high-dimensional feature analysis, are offloaded to detection system 132. This dual-layered approach minimizes bandwidth usage and conserves battery life on mobile devices while maintaining high detection accuracy.

Event detector component 216 dynamically adapts its detection parameters based on contextual environmental data. For instance, the component may increase detection thresholds in high-noise environments, such as urban areas, to avoid false positives, while lowering thresholds in quieter settings to capture subtler EOIs. This adaptability is further enhanced by machine learning insights from machine learning system 136, which provides updated detection models tailored to specific environmental and operational conditions.

The component interacts closely with sensor fusion component 210 to validate detected events through multi-sensor correlation. For instance, if audio data initially flags an anomaly, accelerometer and barometric data are analyzed to confirm or reject the detection. This cross-sensor validation reduces false positives and ensures robust detection even in complex or noisy environments. Once validated, confirmed EOIs are passed to event localization component 221 for geolocation and classification.

Event detector component 216 incorporates mechanisms to dynamically prioritize detections based on confidence scores. For instance, high-confidence detections may trigger immediate geolocation and classification, while low-confidence detections are queued for further analysis. Additionally, flagged detections are archived in event data store 232, providing a valuable repository for auditing, validation, and future model training.

Sensor fusion component 210 is operable to synchronize and process multi-sensor data to validate and refine event detection within detection application 131. Multimodal sensor inputs may include audio signals, barometric pressure readings, accelerometer spikes, and gyroscopic changes, enabling robust event detection. For example, dynamic network formation may prioritize devices with compatible data processing capabilities based on sensor calibration data stored within configuration data store 234. In certain embodiments, the system dynamically forms networks by evaluating proximity to the event, available device resources, and compatibility with the computational requirements of the detected event. For example, devices closer to the event with sufficient CPU capacity and battery life are prioritized, ensuring efficient network operations. Additionally, the network adjusts dynamically as devices join or leave, maintaining robust performance even under changing conditions. More specifically, this component aggregates data streams from various sensors, such as audio, accelerometer, gyroscope, and barometer, ensuring temporal and spatial coherence through precise timestamp synchronization. This enables cross-sensor analysis to identify consistent patterns associated with an Event of Interest (EOI).

In an embodiment, sensor fusion component 210 preprocesses sensor data by resampling and aligning it to a common sampling rate, typically that of the primary sensor (e.g., audio). For instance, gyroscope and accelerometer data are resampled to match the audio data's sampling rate. This allows for consistent representation and correlation across data streams. Wavelet transforms are applied to decompose audio signals into time-frequency components, which are analyzed alongside accelerometer data to detect impulsive events such as explosions or gunfire.

Additionally, sensor fusion component 210 employs Principal Component Analysis (PCA) to identify the dominant axis of motion in three-axis accelerometer data, improving motion event correlation with audio data. For example, PCA helps isolate the shockwave-like motion of a phone during an explosion, correlating it with the accompanying audio signature. In cases where sensor data streams operate at different frequencies, Dynamic Time Warping (DTW) is used to dynamically align these data streams, ensuring temporal consistency during fusion.

In certain embodiments, sensor fusion component 210 applies mutual information analysis to quantify shared information between disparate sensor streams, such as the correlation between audio pressure changes and barometric pressure variations. This analysis aids in determining the likelihood of an EOI by leveraging shared patterns in the fused data.

Sensor fusion component 210 also utilizes neural network-based encoders trained to transform data from different sensor types into a common feature space. These encoders are designed to maximize the similarity of feature vectors during EOIs while minimizing similarity in non-event scenarios. For example, encoded feature vectors from audio, accelerometer, and barometric sensors are compared, and their pairwise correlations are analyzed. If these correlations exceed predefined thresholds, the system flags the event for further processing by event localization component 221.

In conjunction with listening threshold component 214, sensor fusion component 210 initiates data fusion processes once initial detection criteria are met. Processed data is forwarded to event detector component 216, where CFAR detector 219 provides final event validation. This workflow ensures that only high-confidence detections proceed to the localization and classification stages, reducing false positives in complex environments.

Sensor fusion component 210 is operable to interact with resource management component 222 to optimize system performance. Based on confidence scores and detection reliability, the component adjusts sensor sampling rates or prioritizes data processing for specific sensors, balancing CPU load and battery consumption during extended detection scenarios.

In certain embodiments, sensor fusion component 210 incorporates a tiered processing strategy to minimize resource consumption during SEGNet inactivity. Initially, only the primary sensor (e.g., microphone) actively monitors for potential EOIs, while secondary sensors, such as accelerometers or barometers, remain in a dormant state. This approach reduces CPU and battery usage while maintaining readiness for event detection. For example, lightweight statistical techniques, such as threshold-based amplitude analysis or spectral energy detection, are employed by the primary sensor to assess incoming data in real-time. Once an EOI is suspected, the system activates secondary sensors to enhance detection accuracy through multi-sensor fusion.

Upon triggering secondary sensor activation, sensor fusion component 210 integrates their data streams with the primary sensor data for analysis. For instance, synchronized accelerometer and gyroscope data may be used to confirm the physical impact of an explosion detected via audio. This multi-sensor approach applies cross-correlation techniques to align and process sensor data streams, enabling the detection and classification of events using data from multiple sensors.

To further optimize resource utilization, sensor fusion component 210 employs hierarchical data aggregation. Each participating device in the SEGNet performs initial feature extraction, such as calculating normalized power spectral densities or identifying dominant motion axes, before transmitting data to the lead device or detection system 132. This minimizes redundant data transmission across the network, conserving bandwidth and reducing processing overhead. The aggregated and partially processed data is then analyzed collectively to generate refined geolocation estimates and validate EOIs.

Sensor fusion component 210 interacts with other components, such as dynamic resource management component 222, to dynamically adjust sensor activity and sampling rates based on evolving detection confidence levels. This integration ensures that computational resources are allocated effectively during both active and idle SEGNet states, enabling efficient event detection and geolocation while preserving device longevity.

Event localization component 221 is operable to determine the geolocation of an Event of Interest (EOI) using data collected from multiple sensors across the Spontaneously Emergent Geolocation Network (SEGNet). Geolocation techniques include Time Difference of Arrival (TDOA), Angle of Arrival (AoA), and combinations thereof. For instance, TDOA-based geolocation in two dimensions requires at least four devices to resolve ambiguity, whereas TDOA+AoA geolocation may achieve sufficiency with two devices if one includes a vector sensor. AoA-only geolocation requires two or three devices depending on geometry and angle measurement uncertainty. These techniques compute event location by analyzing time-stamped sensor data and directional information.

TDOA estimates can be refined through cross-correlation between sensor pairs to maximize alignment between signal waveforms. AOA methods may utilize coordinate transformations to derive azimuth and elevation angles, integrating results with geospatial metadata for precise localization. In certain embodiments, event localization component 221 may leverage signal processing techniques, such as matched filtering and adaptive beamforming, to enhance geolocation accuracy in challenging environmental conditions. Additionally, event localization component 221 may dynamically adjust its algorithms based on environmental factors and data reliability, ensuring robust performance across diverse scenarios.

For TDOA estimation, event localization component 221 synchronizes time-stamped audio and other sensor data using a GPS-disciplined clock. This ensures that sensor readings from different devices are aligned to a common time reference, allowing accurate computation of time delays. A crude TDOA estimate can initially be derived by calculating the difference in timestamps between detections. This estimate is refined through cross-correlation analysis, where the time offset that maximizes correlation between time series data is calculated and added to the initial timestamp difference. The width of the cross-correlation peak provides an uncertainty estimate, which is used to weight TDOA calculations from multiple devices. For enhanced accuracy, adaptive filtering techniques may be employed to suppress noise and environmental interference.

In an embodiment, secondary sensors, such as accelerometers or barometers, can be integrated into the TDOA computation. These sensors contribute complementary data, particularly in scenarios with noisy or incomplete audio signals. A weighted average of TDOA estimates from multiple devices is calculated, where weights are inversely proportional to the uncertainty of individual measurements. For example, accelerometer data may help refine audio-based TDOA calculations, while barometric data can provide contextual information distinguishing indoor and outdoor EOIs. This integration enables event localization component 221 to achieve higher accuracy across varied operational environments.

AOA estimation is performed using vector sensors, such as 3-axis accelerometers, in conjunction with scalar sensors like microphones or barometers. Event localization component 221 calculates the correlation between the audio signal and accelerometer data along each axis to determine the signal's direction. The accelerometer's coordinate system is rotated to align its z-axis with the signal source, using rotation angles derived from minimizing the correlation between the rotated z-axis and the audio signal. These angles are transformed into an East-North-Up (ENU) coordinate system using magnetometer data, yielding azimuth and polar angles for geolocation. This method effectively suppresses noise from uncorrelated user movements, ensuring accurate AOA estimates. Additionally, error propagation techniques are applied to estimate the uncertainty of the calculated angles, further enhancing reliability.

Once TDOA and AOA estimations are complete, event localization component 221 solves the system of equations that define the EOI's geolocation using methods such as least squares, weighted least squares, or Maximum Likelihood Estimation (MLE). In scenarios with repeated detections over time, the component employs Extended Kalman Filters or Particle Filters to dynamically refine and update the event location. When multiple simultaneous EOIs occur, a Multiple Hypothesis Tracking (MHT) approach is used to maintain distinct geolocation tracks for each signal source. For example, overlapping audio signals are disambiguated through a combination of TDOA, AOA, and cross-correlation estimates.

In certain embodiments, event localization component 221 processes TDOA and AOA estimations with geolocation algorithms to handle practical challenges, such as GPS obstructions. For devices indoors or without direct line-of-sight to GPS satellites, Kalman Filtering is employed to smooth GPS data and estimate device motion using accelerometer and magnetometer inputs. These techniques enable reliable geolocation even under constrained environmental conditions. In other cases, alternative geolocation methods, such as Wi-Fi triangulation or cellular tower proximity, may supplement or replace GPS-based calculations, ensuring consistent system performance.

Event localization component 221 supports dynamic decision-making for whether geolocation computations may be performed locally on the lead device within the SEGNet or offloaded to detection system 132 for remote processing. The decision to perform localization locally or remotely is managed dynamically by resource management component 222. In scenarios involving limited connectivity, initial geolocation estimates may be performed locally and later refined using additional data or computational resources from detection system 132. These configurations ensure robust geolocation performance while optimizing resource usage across the system.

In various embodiments, event localization component 221 integrates with consensus component 314 to validate geolocation results. For example, the consensus component evaluates the consistency of geolocation estimates across participating devices and reconciles discrepancies using machine learning models. Additionally, event localization results are shared with notification system interface 306 or external system interface 308 for dissemination to authorized users or third parties, such as first responders or emergency services. The geolocation data may also be archived in geolocation data store 334 for future analysis, refinement of geolocation algorithms, or machine learning model updates.

Lead device selection component 212 is operable to dynamically assign a lead device within the Spontaneously Emergent Geolocation Network (SEGNet). More specifically, lead device selection component 212 evaluates participating devices based on predefined criteria such as proximity to the Event of Interest (EOI), available computational resources, and network connectivity to determine the most suitable device to act as the lead. In an embodiment, dynamic network formation prioritizes devices compatible with event-specific data processing requirements. Devices with sufficient computational resources and minimal latency are assigned higher weights during SEGNet formation. Event-specific data processing requirements may include the ability to process multimodal sensor inputs, such as audio, accelerometer, and barometric data, or to execute specific geolocation techniques like Time Difference of Arrival (TDOA) or Angle of Arrival (AOA). Compatibility is determined by evaluating each device's sensor capabilities, computational power, and preloaded data processing libraries. For example, a device with a calibrated microphone and accelerometer may be prioritized for audio-motion correlation tasks, while devices with higher CPU capacity may be assigned geolocation computation roles.

Compatibility criteria may include processing speed, battery life, and ability to process multimodal data inputs. In various embodiments, ‘compatibility with event-specific data processing requirements’ includes assessing the operational capabilities of devices relative to the detected event type. For example, audio-based events may prioritize devices with high-fidelity microphones, while seismic events may prioritize devices with accelerometers. Device compatibility may also account for resource availability, such as battery life or processing power, and the system dynamically incorporates or excludes devices based on these criteria. Further, compatibility with event-specific data processing requirements involves evaluating the ability of devices to perform specific detection or geolocation tasks based on their hardware capabilities, sensor configurations, and software readiness. For example, devices equipped with vector sensors are prioritized for geolocation tasks that require angle of arrival (AoA) calculations, while devices with high CPU availability are preferred for real-time signal correlation and machine learning inference. Compatibility assessments may also consider the device's firmware version and ability to integrate seamlessly into the SEGNet framework.

In one embodiment, lead device selection component 212 operates by initiating a device discovery protocol upon the detection of an EOI. This protocol gathers metadata from nearby devices, including GPS location, battery levels, CPU availability, and sensor calibration status. For example, if multiple devices are equidistant from the EOI, the component may prioritize a device with higher computational capacity and longer battery life to ensure efficient task execution and data processing.

Lead device selection component 212 incorporates resource allocation algorithms to optimize SEGNet performance. These algorithms consider real-time environmental and network conditions to dynamically update lead device assignments as necessary. For instance, if the initially selected lead device experiences a significant drop in battery level or loses connectivity, the component can seamlessly transition the leadership role to another device without interrupting ongoing detection or geolocation tasks.

In various embodiments, lead device selection component 212 leverages clustering algorithms to segment devices into subgroups based on their spatial distribution and resource availability. Within each cluster, a lead device is designated to coordinate local data aggregation and processing tasks. This hierarchical approach reduces communication overhead and enhances the overall scalability of the SEGNet, particularly in scenarios with a high density of participating devices.

Lead device selection component 212 may also implement fallback mechanisms for scenarios where no single device meets the ideal criteria for leadership. In such cases, the component can initiate a collaborative leadership model, where multiple devices share the responsibilities of data aggregation and processing. This model ensures redundancy and fault tolerance, allowing the SEGNet to maintain functionality even under suboptimal conditions.

In certain configurations, lead device selection component 212 interfaces with mesh network coordinator 220 to establish secure and efficient communication channels between the lead device and other SEGNet participants. This coordination enables the lead device to distribute detection tasks, synchronize sensor data, and relay aggregated event information to detection system 132 or notification system 134 as required.

Lead device selection component 212 employs various technical methodologies to dynamically determine and assign the lead device within the SEGNet. One such approach involves a weighted scoring algorithm, where each participating device is evaluated based on multiple factors, including its proximity to the EOI, available CPU capacity, and current battery level. A composite score is calculated for each device, and the one with the highest score is selected as the lead. This ensures that the most capable device, in terms of both location and resource availability, takes on the leadership role.

In another embodiment, the component utilizes a consensus-based selection mechanism. Here, devices within the SEGNet communicate their suitability metrics—such as resource levels and connectivity status—and collectively decide on the lead device through a consensus protocol, such as Raft or Paxos. This method ensures a fair and democratic selection process, which is particularly beneficial in environments where device capabilities are relatively uniform, and no single device stands out as the obvious choice.

Additionally, lead device selection component 212 supports dynamic re-election processes. During the operation of the SEGNet, if the lead device's performance metrics, such as battery life or network connectivity, fall below a predefined threshold, the system triggers an automatic re-election. Using real-time data from participating devices, the component swiftly identifies and assigns a new lead device, ensuring seamless continuity in event detection and geolocation tasks without manual intervention.

Sensor data aggregator 218 is operable to collect, synchronize, and preprocess sensor data from multiple devices within the Spontaneously Emergent Geolocation Network (SEGNet) for collaborative event detection and geolocation. Synchronization mechanisms include GPS-disciplined clocks and dynamic time warping (DTW) algorithms to ensure temporal alignment of sensor data. Correlation thresholds are dynamically adjusted based on environmental conditions, such as noise levels and device density. Environmental conditions are evaluated using sensor data collected by the SEGNet. For example, in high-noise environments, thresholds for audio signal correlations are elevated to filter out background interference, while in low-noise scenarios, thresholds are reduced to improve sensitivity. Environmental parameters such as ambient noise, signal interference, and device density are continuously monitored, and the system applies machine learning models or predefined rules to optimize threshold values dynamically. Additionally, the system accounts for device density by prioritizing data from strategically located devices, ensuring accurate correlation analysis. Cross-correlation techniques analyze signal overlap and refine geolocation estimates by evaluating alignment across sensor outputs. More specifically, sensor data aggregator 218 consolidates raw data streams from various sensors, including microphones, accelerometers, gyroscopes, barometers, magnetometers, and cameras, ensuring temporal and spatial alignment across all participating devices.

For example, in an embodiment, sensor data aggregator 218 receives timestamped audio and motion data from multiple devices. It resamples the data streams to match a common sampling rate and aligns them based on their GPS-synchronized timestamps. This ensures coherence across disparate data sources, enabling accurate cross-sensor analysis in subsequent processing stages.

Sensor data aggregator 218 employs various preprocessing techniques to ensure the integrity and consistency of the aggregated data. One such technique involves the use of dynamic time warping (DTW) to align sensor data streams with differing sampling rates. Another approach uses Kalman filtering to smooth noisy sensor data, reducing the impact of environmental interference or device-specific anomalies. Additionally, wavelet transforms may be applied to decompose audio signals into time-frequency representations, enhancing the detection of impulsive events. This preprocessing ensures that the data fed into subsequent components, such as event detector component 216 and event localization component 221, is both reliable and consistent.

In certain embodiments, sensor data aggregator 218 applies a fusion-weighting mechanism, where sensor data from devices with higher confidence levels—based on proximity to the event or sensor calibration accuracy—are given more weight during the aggregation process. For instance, in a multi-device scenario, sensor readings from devices closest to the Event of Interest (EOI) may be prioritized, improving the accuracy of geolocation estimates and event validation.

Sensor data aggregator 218 also integrates with lead device selection component 212 to dynamically route aggregated data to the designated lead device for processing. This ensures that the most resource-capable device in the network performs the computationally intensive tasks, optimizing the overall performance and efficiency of the SEGNet. In certain configurations, sensor data aggregator 218 coordinates with dynamic resource allocation component 323 to manage the computational load and balance resource usage across participating devices, such as throttling non-essential processes to prioritize aggregation tasks.

In various embodiments, sensor data aggregator 218 incorporates mechanisms to minimize resource consumption while maintaining operational effectiveness. For example, low-priority sensors may be deactivated, or their sampling rates reduced when sufficient data has already been aggregated. This approach aligns with strategies employed by dynamic resource allocation component 323 to conserve battery life and computational resources during extended SEGNet operations.

Sensor data aggregator 218 interacts with machine learning models deployed within detection application 131 and detection system 132 to refine its aggregation strategies. These models can predict the relevance of incoming sensor data streams based on learned patterns, such as the likelihood of an EOI occurring in specific environmental conditions or geospatial contexts. This predictive capability enables sensor data aggregator 218 to selectively prioritize and preprocess high-value data streams, enhancing the overall reliability and accuracy of the detection system.

By collecting, synchronizing, and preprocessing sensor data with a focus on efficiency and reliability, sensor data aggregator 218 plays a critical role in enabling accurate event detection and geolocation. Its integration with other system components ensures robust and scalable performance across diverse operating environments and device configurations. Mesh network coordinator 220 is operable to facilitate the establishment and management of peer-to-peer communication within Spontaneously Emergent Geolocation Networks (SEGNets). More specifically, mesh network coordinator 220 dynamically manages the network topology, ensuring efficient data transmission and synchronization between participating devices, such as user device(s) 130 and detection devices 138.

In various embodiments, mesh network coordinator 220 continuously monitors the network environment to adapt to changes in device availability, connectivity, and resource constraints. For instance, as devices join or leave the SEGNet, mesh network coordinator 220 updates the network topology to maintain robust communication pathways. This dynamic topology management ensures that critical event-related data flows seamlessly across the network, even in environments where device connectivity fluctuates due to mobility or power limitations.

Mesh network coordinator 220 optimizes latency and bandwidth by employing data compression and selective transmission techniques. For example, instead of broadcasting raw sensor data, the coordinator may prioritize the transmission of event-relevant data, such as processed audio or geolocation estimates. This reduces the overall data volume transmitted within the network, improving efficiency in connectivity-constrained environments.

In certain embodiments, mesh network coordinator 220 incorporates secure communication protocols to protect event-related data. This includes encryption mechanisms and secure key exchange protocols to prevent unauthorized access and ensure data integrity during transmission. For example, encryption standards like AES-256 could be applied to sensor data exchanged between devices, providing a secure communication layer within the mesh network.

Mesh network coordinator 220 facilitates collaborative data validation among SEGNet devices. For instance, when an Event of Interest (EOI) is detected, the coordinator enables devices to exchange detection results and sensor data for cross-verification. Distributed consensus algorithms may be employed to confirm the occurrence of an EOI, improving the accuracy and reliability of event detection within the network.

To ensure fault tolerance, mesh network coordinator 220 implements redundancy mechanisms, such as data replication. Critical event data, including sensor readings and geolocation estimates, can be replicated across multiple devices in the SEGNet. This redundancy ensures that data remains accessible and can be recovered even if some devices experience power loss or connectivity failures.

In an embodiment, mesh network coordinator 220 supports multi-hop communication, enabling devices to relay data across multiple nodes within the SEGNet. This capability is particularly useful in scenarios where some devices are out of direct communication range. For example, event detection results from a remote device can be transmitted to the lead device via intermediate nodes, ensuring comprehensive data aggregation for event validation and localization.

In certain embodiments, Mesh Network Coordinator 220 is operable to accommodate manual Event of Interest (EOI) reporting as a trigger for SEGNet formation. When a user manually reports an EOI via detection application 131, the component initializes communication between participating devices, establishing peer-to-peer connections or utilizing available network infrastructure. The communication protocols, such as Bluetooth, Wi-Fi Direct, or TCP/IP, remain consistent with those used for automated detections, ensuring interoperability between manual and automated SEGNet activations.

The Mesh Network Coordinator 220 also manages the inclusion of metadata associated with the manual report, such as user-provided annotations or descriptions of the EOI, which can enhance the quality of information shared within the network. In some configurations, the component may prioritize manual reports by relaying user-provided data (e.g., spoken or written observations) to third-party systems or emergency responders. This ensures that both manual and automated EOIs are processed with equal rigor and are capable of triggering real-time SEGNet creation and data exchange.

Mesh network coordinator 220 operates in conjunction with other system components, such as lead device selection component 212, to coordinate network-wide activities. For example, upon the designation of a lead device, mesh network coordinator 220 ensures that all participating devices align their communication efforts and data-sharing priorities under the lead device's guidance. Additionally, real-time feedback from resource management component 222 may inform the coordinator's decisions, optimizing CPU and battery usage across the SEGNet.

Resource management component 222 is operable to optimize the computational and power resources of user device(s) 130 during SEGNet operation. More specifically, resource management component 222 dynamically adjusts resource allocation for various detection and data processing tasks, ensuring efficient operation under varying system loads and environmental conditions. Geolocation processing tasks are distributed across devices in the network to optimize resource consumption. In various embodiments, sharing geolocation processing tasks involves distributing computational workloads across multiple devices within the network to optimize resource utilization and reduce processing time. For example, one device may compute Time Difference of Arrival (TDOA) metrics, while another device calculates Angle of Arrival (AoA) estimates. Devices may also dynamically offload tasks based on their available resources, such as battery life or processing power, ensuring that the network remains operational even under constrained conditions. The distributed approach mitigates the risk of overloading individual devices and enhances overall network efficiency. In another example, devices closer to the event may handle initial geolocation computations, while downstream tasks, such as error propagation and uncertainty minimization, are delegated to higher-capacity devices or remote servers. This component plays a critical role in maintaining the longevity of device functionality by regulating CPU usage, memory allocation, and sensor activity based on real-time system demands.

In an embodiment, resource management component 222 employs a two-tier detection architecture. The primary tier utilizes a low-power detection process to continuously monitor sensor data for potential Events of Interest (EOIs). Upon triggering, the secondary tier initiates more computationally intensive processes, such as signal validation and geolocation, allowing the system to conserve resources during periods of inactivity.

For example, the primary detection process may involve a Constant False Alarm Rate (CFAR) detector that operates with minimal CPU usage to identify anomalies in incoming sensor data. When an anomaly is detected, resource management component 222 activates secondary processes that apply more complex detection methods, such as likelihood-ratio tests or machine learning-based validation, to confirm the EOI.

Resource management component 222 is operable to offload certain computational tasks to detection system 132 when local device resources are constrained. For instance, in scenarios where high computational demand exceeds the capacity of user device(s) 130, the component transmits raw or preprocessed sensor data to a remote server for further analysis.

In certain embodiments, resource management component 222 dynamically adjusts sensor sampling rates and prioritizes computational tasks based on system conditions. For example, during periods of low activity, sensor sampling rates may be reduced to conserve power. Conversely, when an EOI is detected, the component increases resource allocation to support real-time data analysis and event confirmation.

Resource management component 222 operates in coordination with other components, such as sensor fusion component 210 and listening threshold component 214, to streamline data processing and optimize overall system performance. This coordination ensures efficient resource utilization while maintaining accurate detection and geolocation capabilities.

Sensor Data Store 230 is operable to temporarily store raw and preprocessed data captured by various sensors on user device(s) 130, including audio recordings, geolocation data, barometric pressure, gyroscope readings, accelerometer data, magnetometer data, and images. More specifically, sensor data store 230 serves as a temporary cache, supporting real-time processing requirements for components such as sensor fusion component 210, event detector component 216, and event localization component 221.

In an embodiment, sensor data store 230 is configured to handle timestamped data streams from multiple sensors, enabling precise temporal alignment for subsequent analysis. For example, sensor data store 230 facilitates the synchronization of audio data with accelerometer and gyroscope readings to enhance event detection accuracy. Additionally, sensor data store 230 supports the storage of intermediate data outputs, such as transformed sensor data or encoded feature vectors generated by neural network encoders.

Sensor data store 230 incorporates mechanisms to manage data lifecycles, including automated data purging after data has been processed and validated by event detector component 216. In certain embodiments, data purging is delayed for events flagged as high-priority, preserving the sensor data for further analysis or transmission to detection system 132. The data store may also implement data compression techniques to optimize storage capacity, particularly when handling high-resolution audio or image data.

In various configurations, sensor data store 230 operates in conjunction with resource management component 222 to regulate data retention policies based on device resource availability. For instance, during low-power states, non-critical sensor data may be discarded to conserve storage space and battery life, while critical event-related data is retained for further processing or transmission.

In certain embodiments, sensor data store 230 supports asynchronous data transmission, buffering sensor data for upload to detection system 132 or machine learning system 136 when network conditions permit.

Event data store 232 is operable to store event-related data for confirmed Events of Interest (EOIs), including raw sensor data, processed data, and event metadata. More specifically, event data store 232 serves as a centralized repository for archiving data associated with detected events, providing a comprehensive record that can be accessed for post-event analysis, model refinement, and system validation.

In an embodiment, event data store 232 stores sensor data such as audio recordings, geolocation coordinates, barometric readings, accelerometer data, gyroscopic measurements, and magnetometer data corresponding to detected EOIs. This data is supplemented with event metadata, including timestamps, detection thresholds, sensor fusion results, and event classifications generated by event detector component 216.

For example, when an EOI is confirmed, the corresponding data is logged and indexed within event data store 232. This allows for efficient retrieval and analysis of past events, enabling machine learning system 136 to utilize the archived data for model training and performance evaluation. In certain embodiments, event data store 232 organizes data hierarchically, categorizing events by type, severity, or detection location to facilitate structured querying and retrieval.

Event data store 232 also supports data integrity and consistency checks. In various configurations, the data store applies hashing or cryptographic techniques to ensure that archived data remains unaltered. Additionally, event data store 232 may include version control mechanisms for events, enabling the system to track changes or updates to event classifications and associated metadata over time.

In certain embodiments, event data store 232 operates in conjunction with notification system 134, ensuring that relevant event data is readily accessible for dissemination to authorized users and third-party systems. For instance, archived event data can be transmitted upon request to external systems, such as emergency responders or regulatory bodies, for further investigation or validation.

In various configurations, event data store 232 integrates with resource management component 222 to manage storage capacity. For example, the system may implement retention policies, automatically archiving or deleting older event logs based on predefined criteria, such as event age, severity, or storage limits.

Configuration data store 234 is operable to store and manage configuration settings and operational parameters for detection application 131. More specifically, configuration data store 234 maintains data related to system preferences, detection thresholds, sensor calibration settings, network configurations, and operational modes for various system components, including event detector component 216, sensor fusion component 210, and resource management component 222.

In an embodiment, configuration data store 234 stores dynamic detection parameters, such as thresholds for listening threshold component 214 and CFAR detector 219. These parameters can be updated in real-time based on environmental conditions, system feedback, or model updates from machine learning system 136. For example, if machine learning system 136 identifies a need for a lower detection threshold to improve event sensitivity in a particular environment, the updated threshold values are stored in configuration data store 234 and automatically applied across relevant system components.

Configuration data store 234 also stores calibration data for sensors integrated within user device(s) 130 and detection devices 138. This data ensures that sensor readings, such as gyroscopic or barometric measurements, remain accurate and consistent across different devices and environmental conditions. For instance, calibration offsets for accelerometers or microphones are retrieved from configuration data store 234 and applied during data preprocessing.

In various embodiments, configuration data store 234 includes network configuration details, such as communication protocols, preferred network interfaces, and server connection settings. These configurations enable detection application 131 to adapt to different network environments, ensuring efficient and secure data transmission between system components.

For example, configuration data store 234 may store settings for fallback modes in scenarios where primary network connections are unavailable. In such cases, the system retrieves alternative communication protocols (e.g., switching from Wi-Fi to cellular data) from the configuration data store to maintain connectivity with detection system 132 and notification system 134.

In certain embodiments, configuration data store 234 operates in conjunction with resource management component 222 to optimize system performance. For instance, the data store may contain predefined resource usage profiles, enabling dynamic adjustments to CPU, memory, or battery consumption based on the current operational context or user preferences.

Additionally, configuration data store 234 supports version control for configuration updates. This ensures that historical configurations can be retrieved and applied if system rollback or troubleshooting is required. Configuration data store 234 may also log changes to operational parameters, providing an audit trail for system administrators or developers to review past adjustments.

Model data store 231 is operable to store and manage machine learning models and associated parameters used by detection application 131 for real-time event detection, classification, and sensor fusion tasks. These models, provided by machine learning system 136, are optimized for deployment on user devices, enabling efficient, low-latency processing. More specifically, model data store 231 maintains the latest versions of the models, ensuring that detection application 131 operates with the most up-to-date configurations. The store also supports version control and rollback mechanisms, enabling rapid deployment of model updates and providing fallback options in case of errors or performance degradation.

In various embodiments, model data store 231 holds auxiliary data related to the models, including training metadata, model evaluation metrics, and performance benchmarks. This information supports offline performance analysis, allowing detection application 131 to monitor the effectiveness of different models and inform subsequent updates or refinements.

Model data store 231 can accommodate a range of model architectures, tailored to the computational capabilities of the user devices. For example, lightweight models such as Convolutional Neural Networks (CNNs) or Long Short-Term Memory (LSTM) networks may be stored for devices with limited processing power. These models offer efficient time-series analysis while maintaining low resource consumption, ensuring compatibility with devices relying on central processing units (CPUs) or basic hardware accelerators.

For devices equipped with more advanced hardware, such as Graphics Processing Units (GPUs) or Tensor Processing Units (TPUs), model data store 231 may house larger models, including Transformer-based architectures. These models, leveraging built-in attention mechanisms, are capable of handling more complex event detection scenarios. However, due to their higher computational demands, these models are selectively deployed based on the device's hardware capabilities and specific operational contexts.

In certain embodiments, model data store 231 facilitates incremental model updates. This allows machine learning system 136 to deploy refined models based on evolving data patterns and feedback from ongoing operations. These updates may include specialized configurations for different environments or event types, enabling detection application 131 to adapt dynamically to changing conditions within the Spontaneously Emergent Geolocation Network (SEGNet).

Model data store 231 may further integrate with resource management component 222 to optimize model selection based on the device's real-time resource usage, such as CPU load, memory capacity, and battery life. By coordinating model deployment with resource availability, the system ensures efficient processing while maintaining high detection accuracy and responsiveness.

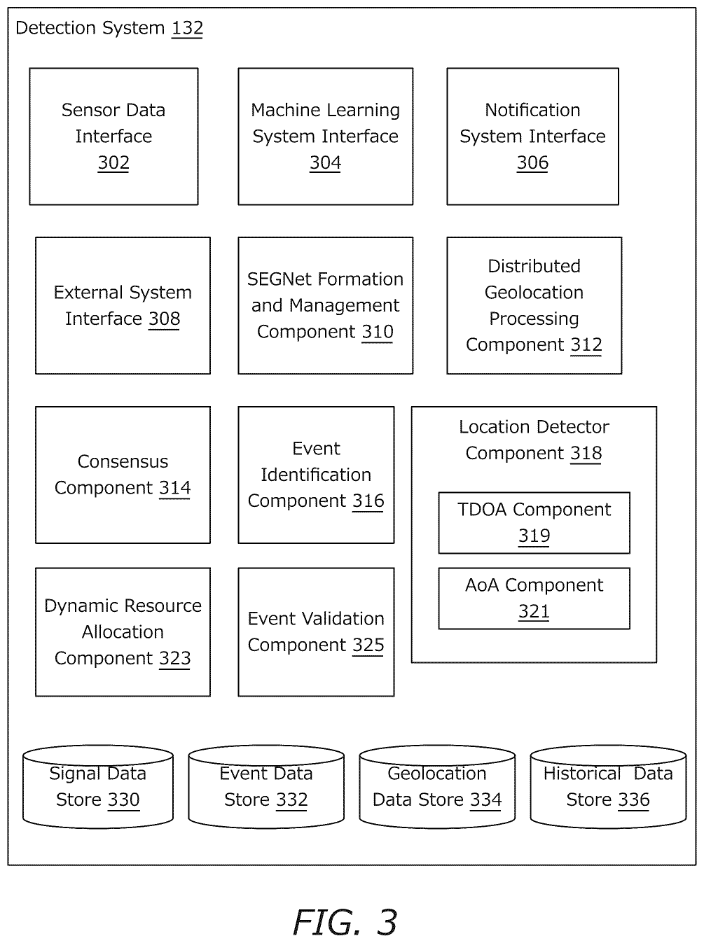

FIG. 3 illustrates an exemplary embodiment of detection system 132, which operates as the central processing unit for managing Spontaneously Emergent Geolocation Networks (SEGNets) in accordance with various embodiments. Detection system 132 comprises several interfaces, including sensor data interface 302, machine learning system interface 304, notification system interface 306, and external system interface 308, each facilitating communication with external devices and systems. Additionally, detection system 132 integrates data stores, including signal data store 330, event data store 332, geolocation data store 334, and historical data store 336, to support data storage, retrieval, and management.

Detection system 132 performs functionalities through various components, including SEGNet formation and management component 310, distributed geolocation processing component 312, consensus component 314, event identification component 316, location detector component 318 comprising TDOA component 319 and AoA component 321, dynamic resource allocation component 323, and event validation component 325. These components work collaboratively to facilitate the detection, identification, and geolocation of events within SEGNets. Each component leverages incoming data from connected devices to process and validate event-related information, ensuring accurate and efficient geolocation while maintaining data integrity and synchronization across the network.

In various embodiments, the components of detection system 132 are operable to function independently of detection application 131 or in conjunction with it, depending on the operational context and system configuration. This flexibility allows the detection system to dynamically allocate processing responsibilities between participating mobile devices and centralized or distributed detection systems. For example, in scenarios where connectivity to detection system 132 is unavailable or limited, certain components, such as the SEGNet formation and management component 310, may operate autonomously within detection application 131 to perform localized processing and geolocation tasks. Conversely, when connectivity is available, these components may interact with detection system 132 to offload computationally intensive tasks or aggregate data from multiple SEGNets for system-wide analysis. This adaptive framework ensures that the system maintains robust performance across a wide range of deployment environments and network conditions, supporting both edge and cloud-based operational modes as appropriate.

Sensor data interface 302 is operable to manage the flow of raw and preprocessed sensor data between participating mobile devices within the SEGNet and detection system 132. More specifically, sensor data interface 302 facilitates the real-time collection, validation, and transfer of sensor data such as audio signals, accelerometer readings, barometric pressure, gyroscope data, and magnetometer outputs. This interface ensures that all relevant data streams are accurately transmitted for analysis by other components within detection system 132.

For example, sensor data interface 302 processes incoming data to ensure temporal and spatial alignment across participating devices in the SEGNet. Timestamp synchronization is used to align sensor readings, enabling accurate time difference of arrival (TDOA) and frequency difference of arrival (FDOA) calculations. The interface also implements error-checking protocols to validate the integrity and consistency of transmitted sensor data.

In certain embodiments, sensor data interface 302 supports both real-time and batch data transmission modes. Real-time data streams are prioritized for immediate processing by SEGNet formation and management component 310 and event identification component 316, while batch transmission modes are utilized for delayed or asynchronous data uploads when network conditions are constrained.

Sensor data interface 302 operates using secure communication protocols, such as HTTPS, gRPC, or MQTT, to maintain data confidentiality and integrity. Encryption mechanisms may be employed to prevent unauthorized access to sensor data, particularly for sensitive geolocation and timestamp information.

Additionally, sensor data interface 302 supports bidirectional communication with user device(s) 130, enabling feedback to be sent back to participating devices. For instance, upon successful processing of sensor data, the interface can transmit confirmation signals or updated detection thresholds to improve local detection accuracy within the SEGNet.

Notification system interface 306 is operable to manage communication between detection system 132 and notification system 134. More specifically, it facilitates the transmission of event-related information, such as geolocation data, event classifications, and sensor metadata, to authorized users, emergency responders, and third-party systems via notification system 134.

For example, notification system interface 306 packages and transmits event data that includes precise geolocation coordinates, timestamped detection information, and additional contextual data from participating devices, such as audio recordings, barometric pressure readings, or accelerometer data. This interface ensures that the transmitted data is compatible with downstream notification channels, which may include SMS, email, push notifications, or API-based integrations with third-party platforms.

In certain embodiments, notification system interface 306 is configured to prioritize notifications based on event type, severity, or proximity to critical infrastructure or populations. For instance, high-severity events, such as explosions or gunshots, may trigger immediate alerts to emergency responders, while lower-priority events are queued for batch processing or archival purposes.

Notification system interface 306 supports secure communication protocols, such as HTTPS, MQTT, or TLS-encrypted REST APIs, to ensure data integrity and confidentiality. These protocols safeguard sensitive information during transmission, protecting it from unauthorized access or tampering.

In various embodiments, notification system interface 306 supports bidirectional communication, allowing notification system 134 to relay acknowledgment messages or recipient feedback back to Detection system 132. For example, emergency responders might confirm receipt of an alert or provide situational updates, which can be logged and processed by Detection system 132 for future system adjustments.

Notification System Interface 306 is also operable to integrate with other components of Detection system 132. For instance, it works in conjunction with SEGNet Formation and Management Component 310 to ensure that alerts are based on validated, high-confidence event detections. Additionally, it may leverage insights from Machine learning system interface 304 to refine notification criteria over time, ensuring that alerts remain relevant and accurate as new data patterns emerge.

External system interface 308 is operable to manage data exchange between detection system 132 and external systems not directly integrated into the SEGNet or the notification system. More specifically, it enables the system to share relevant event-related data, geolocation results, and analytics with external platforms, such as third-party data aggregators, research databases, or government systems.

For example, external system interface 308 may transmit aggregated data on detected events, including geolocation trends and classification statistics, to research institutions studying urban noise patterns or environmental monitoring systems tracking seismic or atmospheric events. This interface ensures that the data format aligns with external system requirements, such as compliance with JSON, XML, or other standardized data schemas.

In certain embodiments, external system interface 308 enables real-time or near-real-time integration with external systems via API-based communication. For instance, emergency management platforms might receive real-time data streams on detected events to integrate with natural disaster response workflows. Similarly, third-party AI services might access raw or processed event data to enhance their models or perform secondary analyses.

External system interface 308 operates using secure and robust communication protocols, such as REST APIs, WebSocket connections, or data streams through secure MQTT channels. It incorporates encryption and authentication mechanisms, such as OAuth 2.0, to ensure that sensitive event information is only accessible to authorized external systems.

In various embodiments, external system interface 308 supports asynchronous data transmission to ensure data integrity, even in cases of intermittent connectivity. This functionality is particularly useful when integrating with external systems that may not always maintain a persistent connection.

Additionally, external system interface 308 is operable to log interactions with external systems in event data store 232 or geolocation data store 334 for audit and tracking purposes. This ensures traceability and accountability for data shared with external entities, supporting compliance with regulatory or operational requirements.

External system interface 308 integrates with other components of detection system 132. For instance, it works in conjunction with machine learning system interface 304 to share anonymized event data for external model development or collaborative research. Furthermore, it collaborates with SEGNet formation and management component 310 to provide external systems with insights into network-level event detection dynamics.

SEGNet formation and management component 310 is operable to coordinate the spontaneous formation and management of Spontaneously Emergent Geolocation Networks (SEGNets) in response to the detection of an Event of Interest (EOI). More specifically, this component enables dynamic interactions between participating devices, ensuring efficient collaboration for event detection, validation, and geolocation. SEGNet Formation and Management Component 310 is configured to operate autonomously or in conjunction with Detection System 132, depending on system configurations and the operational context.

For example, upon detecting an EOI, SEGNet Formation and Management Component 310 initiates the SEGNet by identifying and selecting nearby devices capable of participating in the network. This process may incorporate methods such as monitoring sensor data from smartphones within the geographical vicinity of the EOI, including devices equipped with compatible sensor monitoring applications, applying predefined criteria, such as proximity to the EOI, device resource availability (e.g., CPU, battery), and sensor configuration, to select participating devices, leveraging network discovery protocols, including Wi-Fi Direct, Bluetooth, Zigbee, or 5G, to establish direct communication channels between selected devices, etc.

In various embodiments, SEGNet formation and management component 310 coordinates the assignment of roles within the network. In certain embodiments, compatibility with event-specific data processing requirements includes evaluating sensor configurations, device computational capabilities, and network latency. For instance, devices equipped with high-sensitivity microphones may be prioritized for audio-focused events, while those with accelerometers and gyroscopes are selected for motion-based event detection. The system dynamically adjusts the selection criteria based on real-time event characteristics and available resources. For instance, a lead device may be selected based on its proximity to the event, resource availability, or connectivity status. This lead device acts as a coordinator for data aggregation, synchronization, and decision-making within the SEGNet. Other devices contribute by capturing and transmitting sensor data, performing localized processing, or relaying information to detection system 132.

SEGNet formation and management component 310 is also operable to manage the lifecycle of the SEGNet. For instance, once an EOI has been fully processed and geolocated, the component may dissolve the SEGNet, releasing participating devices from their temporary roles to conserve resources. In certain configurations, the component may extend the SEGNet's activity if additional events are detected within a predefined timeframe or geographical radius.

To ensure efficient operation, SEGNet formation and management component 310 incorporates synchronization mechanisms. For example, it aligns timestamps across devices to enable coherent analysis of sensor data, crucial for geolocation and event validation tasks. The component may also monitor the health and status of the network, identifying and replacing devices that drop out due to resource constraints or connectivity issues.

In certain embodiments, SEGNet formation and management component 310 integrates with other system components, such as machine learning system interface 304. For instance, it may use machine learning insights to optimize device selection and resource allocation within the SEGNet. Additionally, it ensures that the data collected by SEGNet devices is appropriately aggregated and transmitted to the location detector component 318 for geolocation and further analysis.

SEGNet formation and management component 310 incorporates additional resource-conservation mechanisms to optimize the performance and longevity of participating devices within a SEGNet. In certain embodiments, the component uses an inactive monitoring mode when the SEGNet is idle or no EOIs are detected. During this mode, only lightweight detection algorithms, such as envelope detection or CFAR thresholds, are active. These algorithms consume minimal computational resources, ensuring the device's battery life and CPU performance are preserved. When a potential EOI is detected, the component transitions to an active mode, initiating SEGNet formation and performing resource-intensive geolocation and event analysis tasks.

To further conserve resources, SEGNet formation and management component 310 employs distributed processing strategies within the SEGNet. For example, the lead device in the network performs primary aggregation and preliminary analysis of sensor data from neighboring devices. Complex computations, such as likelihood ratio tests or machine learning inference for event validation, are then offloaded to detection system 132 when network connectivity is available. This distributed framework allows the SEGNet to balance the computational workload between edge devices and centralized resources, ensuring efficient operation even under constrained conditions.

In an embodiment, the component integrates adaptive communication protocols that dynamically select the most efficient communication medium based on resource availability and network conditions. For instance, when the SEGNet operates in proximity, low-power communication options, such as Bluetooth or Wi-Fi Direct, are prioritized to reduce energy consumption. Conversely, in scenarios requiring broader reach or higher bandwidth, the component may switch to 5G or cellular networks for data transmission.

SEGNet formation and management component 310 also incorporates hierarchical role assignment to further optimize resource utilization. Participating devices are assigned roles based on parameters such as battery life, processing power, and proximity to the EOI. Devices with higher resource availability are prioritized for lead roles, handling tasks such as aggregation and data synchronization. Conversely, devices with limited resources contribute minimally, such as relaying data or performing basic detection.

The component includes failover mechanisms to ensure SEGNet stability in the event of device dropout or connectivity loss. For example, if the lead device becomes unavailable, SEGNet formation and management component 310 automatically designates a new lead device from the remaining participants based on predefined criteria. This mechanism ensures uninterrupted SEGNet operation, maintaining data collection and processing continuity.

In certain embodiments, SEGNet formation and management component 310 is operable to support manual Event of Interest (EOI) reporting as an alternative to automated detection. In this scenario, a user observes an EOI and manually initiates SEGNet formation via a reporting feature in detection application 131. Upon receiving the manual report, the component triggers the same SEGNet activation process used for automated detection, identifying nearby devices for participation based on factors such as proximity, resource availability, and sensor capabilities.

Additionally, SEGNet formation and management component 310 may facilitate integration with external communication features. For instance, the manual reporting functionality can be configured to automatically notify third parties, such as emergency responders or predefined contacts, by dialing a stored number or transmitting an alert message. The third party may then access SEGNet-generated information, including geolocation data, sensor readings, and any annotations provided by the user. This capability ensures that manual EOI reports are seamlessly integrated into the SEGNet workflow, enabling consistent activation and information sharing across detection modes.

SEGNet formation and management component 310 employs secure communication protocols to protect data transmitted within the SEGNet. Encryption and authentication mechanisms prevent unauthorized access and ensure the integrity of the collected data. This is particularly important for maintaining trust and reliability within the network, especially when transmitting sensitive sensor data.

Distributed geolocation processing component 312 is operable to perform geolocation computations by aggregating, analyzing, and refining data from devices participating in the SEGNet. More specifically, this component processes sensor data, time-of-detection information, and geolocation estimates received from the SEGNet's participating devices, ensuring accurate localization of the Event of Interest (EOI).

For example, distributed geolocation processing component 312 utilizes Time Difference of Arrival (TDOA) and Frequency Difference of Arrival (FDOA) techniques to calculate geolocation coordinates based on the relative timing and frequency shifts of signals captured by multiple devices. The component receives timestamped audio or motion data from SEGNet devices, aligns the data using cross-correlation techniques, and calculates the TDOA by identifying the time offset that maximizes correlation. This allows for precise localization of the event's origin by triangulating its position relative to the participating devices.

In certain embodiments, distributed geolocation processing component 312 incorporates Angle of Arrival (AOA) estimation to enhance geolocation accuracy. Using accelerometer and magnetometer data, AOA estimation determines the direction of the event's source relative to each device, complementing TDOA calculations. For instance, accelerometer data is rotated and aligned to minimize correlation noise, while magnetometer readings provide orientation information for translating device-specific angles into a global coordinate system.

Distributed geolocation processing component 312 also employs weighted consensus algorithms to consolidate geolocation estimates from multiple devices. In an embodiment, the component assigns weights to each device's data based on signal quality, sensor accuracy, or environmental factors, such as interference or obstruction. These weighted estimates are combined using techniques such as least-squares fitting or Maximum Likelihood Estimation (MLE) to produce a single, refined geolocation result.

To handle varying network conditions and device capabilities, distributed geolocation processing component 312 operates in both centralized and decentralized modes. In centralized mode, geolocation computations are performed by detection system 132, with participating devices transmitting their data for processing. In decentralized mode, SEGNet devices collaborate to perform distributed geolocation calculations, sharing intermediate results with Detection System 132 only when network connectivity allows.

This component interfaces with event identification component 316 and consensus component 314 to ensure that validated and consistent data is used in geolocation calculations. For instance, distributed geolocation processing component 312 may receive data that has passed consensus verification, ensuring the reliability of geolocation outputs. It also collaborates with location detector component 318 for confirmation and adjustment of event locations.

In certain embodiments, distributed geolocation processing component 312 integrates error correction mechanisms to account for inaccuracies in sensor readings or device locations. These mechanisms include Kalman Filters for refining TDOA/AOA estimates over time and Particle Filters for managing scenarios with multiple potential event locations. By iteratively refining geolocation results, the component ensures high accuracy even in complex environments with overlapping EOIs or signal interference.

Distributed geolocation processing component 312 supports real-time geolocation processing, enabling rapid identification and response to detected events. It maintains a balance between computational efficiency and geolocation precision by dynamically adjusting processing parameters based on the SEGNet's resource constraints, environmental factors, and system requirements.

Consensus component 314 is operable to validate the collective input received from participating devices within the Spontaneously Emergent Geolocation Network (SEGNet). More specifically, this component ensures that the data submitted by multiple devices aligns sufficiently to warrant proceeding with event detection, identification, and geolocation tasks. By filtering out inconsistencies or outlier data, consensus component 314 establishes a reliable dataset for downstream processing.

For example, in an embodiment, consensus component 314 evaluates the sensor data transmitted by SEGNet devices, such as audio signals, geolocation coordinates, and accelerometer readings. This evaluation involves analyzing time-stamped sensor data to determine temporal synchronization and assessing spatial consistency across geolocation estimates. If discrepancies arise, the component may exclude unreliable data points from the consensus, ensuring that only consistent and credible data is passed to downstream components like event identification component 316. Additionally, consensus component 314 incorporates probabilistic modeling techniques, such as Bayesian inference, to refine the reconciliation of geolocation estimates. By leveraging prior probabilities and observed data, the component computes posterior distributions for each geolocation estimate, quantifying uncertainty and improving decision-making. For example, Bayesian inference allows the system to combine multiple estimates probabilistically, ensuring the final geolocation accounts for all available data while prioritizing high-confidence contributions.

In certain embodiments, consensus component 314 employs statistical and computational techniques to validate the incoming data. These techniques may include clustering algorithms to identify and group similar data patterns, cross-correlation analysis to assess signal coherence, and outlier detection methods such as Mahalanobis Distance or robust Z-scores. For example, if three devices in the SEGNet detect an audio signal with matching frequency characteristics but a fourth device reports a conflicting signal, the component may flag the outlier for exclusion based on statistical thresholds. Consensus component 314 may also apply clustering algorithms, such as k-means or DBSCAN, to group geolocation estimates into clusters representing potential EOI locations. These clusters are analyzed to identify the most probable geolocation based on cluster density and size, enabling the system to resolve ambiguities in scenarios involving overlapping or inconsistent estimates.

Consensus component 314 is also operable to determine the sufficiency of participating devices in the SEGNet. For instance, if fewer than a predefined minimum number of devices contribute data, the component may delay processing until additional devices join the SEGNet, ensuring robust validation and geolocation accuracy. Conversely, if an excessive number of devices contribute redundant data, the component may prioritize inputs based on device proximity, resource availability, or signal quality to optimize processing efficiency. To optimize resource efficiency, consensus component 314 dynamically adjusts its algorithms based on network conditions and resource availability. For example, during high-load scenarios, the component may simplify its reconciliation methods by using approximate algorithms, such as stochastic sampling, to generate quick but reliable consensus results. Conversely, in low-load conditions, it employs more computationally intensive methods, such as full Bayesian updates or exhaustive clustering, to maximize accuracy.

In various configurations, consensus component 314 interfaces with SEGNet Formation and management component 310 and distributed geolocation processing component 312 to coordinate data validation efforts. For example, upon receiving data flagged as inconsistent or unreliable, SEGNet formation and management component 310 may reassign roles within the SEGNet or prompt additional devices to contribute data. Similarly, distributed geolocation processing component 312 may refine geolocation estimates based on the validated consensus data. In scenarios involving multiple simultaneous EOIs, consensus component 314 supports Multiple Hypothesis Tracking (MHT) to distinguish between different sources. This capability enables the system to generate distinct consensus results for overlapping EOIs within the same geographical area, ensuring that detection and geolocation remain accurate even under complex conditions.

In certain embodiments, consensus component 314 integrates with machine learning models deployed by machine learning system interface 304 to enhance its validation capabilities. These models may be trained to identify data patterns associated with reliable event detections, allowing the component to adapt dynamically to new environments or sensor conditions. For instance, the models could distinguish between genuine EOIs and environmental noise, refining the consensus validation process over time. Additionally, the component incorporates a feedback mechanism, wherein recurring patterns in geolocation errors are communicated to machine learning system 136 for model refinement. Updated models are deployed to improve the accuracy of consensus operations, creating a dynamic feedback loop that continuously enhances system performance.

Event identification component 316 is operable to analyze and correlate sensor data received from participating devices within the Spontaneously Emergent Geolocation Network (SEGNet) to identify and confirm the occurrence of Events of Interest (EOIs). This component processes data such as audio signals, barometric readings, accelerometer outputs, and geolocation data using a combination of signal processing techniques, machine learning classifiers, and multi-sensor correlation metrics. In various embodiments, event identification component 316 applies time-domain and frequency-domain analysis to raw audio signals, converting them into frequency representations using Fourier Transform techniques to detect characteristic peaks indicative of EOIs, such as explosions or gunshots. To enhance detection reliability, this component may utilize neural network-based classifiers, including Convolutional Neural Networks (CNNs) or Long Short-Term Memory (LSTM) models, trained to recognize unique signal patterns and differentiate them from background noise. Additionally, correlation metrics are employed to analyze multi-sensor relationships, such as comparing accelerometer data with audio signals to confirm shockwave events or identifying correlations between barometric and motion data to validate environmental changes.

In certain embodiments, event identification component 316 normalizes and synchronizes incoming sensor data from SEGNet devices, ensuring temporal alignment across varying sampling rates and device configurations. For example, accelerometer readings and audio signals may be dynamically resampled to a common rate to support coherent analysis. This synchronization enables the component to efficiently aggregate data from multiple sources, reducing false alarms and improving classification accuracy. The component may also dynamically adjust its detection thresholds based on environmental feedback or input from machine learning system 136, adapting to variations in noise levels, device sensitivity, or network activity. For instance, in high-noise urban settings, thresholds can be modified to prioritize events with higher confidence scores, ensuring reliable detection.

Upon confirming an EOI, event identification component 316 forwards event-specific data, such as timestamps, synchronized sensor readings, and device locations, to location detector component 318 for further geolocation processing. In certain configurations, the component collaborates with consensus component 314 and SEGNet formation and management component 310 to validate detection results across the SEGNet before initiating geolocation procedures. Additionally, this component supports retrospective analysis by accessing archived data from historical data store 236, allowing for post-event identification and validation when real-time detection is infeasible. The flexible integration of event identification component 316 with detection system 132 and detection application 131 enables both distributed and centralized operation, ensuring consistent performance across a range of deployment scenarios and network conditions.

Location Detector Component 318 is operable to calculate the geolocation of an Event of Interest (EOI) by analyzing time-domain and spatial data collected from participating devices within the Spontaneously Emergent Geolocation Network (SEGNet). This component integrates data processed by Event Identification Component 316 and applies algorithms to perform Time Difference of Arrival (TDOA) and/or Angle of Arrival (AoA) calculations.

TDOA Component 319 is configured to estimate the relative time differences in signal arrival across multiple SEGNet devices. TDOA Component 319 processes timestamped sensor data, synchronized using GPS-disciplined clocks or internal device clocks, to calculate the time offsets between signal arrivals. These offsets are refined by applying cross-correlation techniques to maximize alignment between the time series data collected from participating devices. For example, the component calculates the cross-correlation of audio data recorded by two devices to identify the time lag corresponding to the highest correlation peak. This refined TDOA estimate, along with its associated uncertainty metric, is then used to compute the relative distances between the event source and each device.

In certain embodiments, TDOA Component 319 integrates secondary sensor data, such as accelerometer or barometer readings, to refine TDOA estimates by incorporating additional environmental context. For example, in a scenario where an EOI generates both an acoustic shockwave and a pressure change, the component analyzes the barometric pressure fluctuations alongside the primary audio data. The barometric sensor provides time-stamped data on rapid pressure changes, which are cross-referenced with the audio signal to verify and refine the time difference calculations. Similarly, accelerometer data capturing vibrations associated with the event can be synchronized with the audio signal to enhance the temporal alignment of the TDOA estimate. This reduces the uncertainty in time offset calculations, particularly in noisy environments.

AoA Component 321 is operable to estimate the direction of the signal source relative to each participating device using multi-axis sensor data. In an embodiment, AoA Component 321 pairs accelerometer data with audio signals to determine the angle of arrival of a detected event. The component rotates the three-axis accelerometer data to align the z-axis with the direction of maximum correlation between the accelerometer readings and audio data, thereby determining the azimuth angle of the signal. Magnetometer data is further utilized to translate this directional information into an East-North-Up (ENU) coordinate system for consistent geospatial representation. Additionally, the component calculates the polar angle, enabling three-dimensional geolocation in scenarios where elevation data is required. AoA Component 321 applies filtering and uncertainty estimation techniques, such as covariance analysis and error propagation, to mitigate inaccuracies caused by device movement or environmental noise.

Location detector component 318 combines the outputs of TDOA component 319 and AoA component 321 to triangulate the precise geolocation of the EOI. In certain embodiments, the component employs weighted least squares, maximum likelihood estimation, or Kalman filtering to solve the system of equations derived from TDOA and AoA calculations. For example, the geolocation of the event source is determined by finding the point that minimizes the error between the observed TDOA and AoA measurements and their theoretical values based on the event's location. To account for repeated detections over time, location detector component 318 may implement an Extended Kalman Filter or Particle Filter to track and update the event's location dynamically.

In configurations involving multiple concurrent EOIs, location detector component 318 integrates with consensus component 314 to disambiguate overlapping detections and associate TDOA and AoA measurements with their respective events. This ensures that geolocation results are accurate and unambiguous, even in scenarios with dense event activity or complex network configurations. Additionally, the component archives geolocation results and associated detection data in geolocation data store 334 for future reference, validation, or retraining of machine learning models.

In various embodiments, location detector component 318 operates in a distributed or centralized manner, depending on system configuration and network conditions. For example, when network connectivity is available, computationally intensive tasks such as TDOA and AoA processing may be offloaded to detection system 132 for centralized analysis. Conversely, in edge scenarios, location detector component 318 may execute these tasks locally within detection application 131, leveraging device-level resources for real-time geolocation. This adaptive operation ensures robust geolocation capabilities across diverse deployment environments and use cases.

Dynamic resource allocation component 323 is operable to optimize the utilization of computational, energy, and network resources across participating devices within the Spontaneously Emergent Geolocation Network (SEGNet) and detection system 132. More specifically, this component dynamically adjusts resource allocation strategies to meet the operational requirements of event detection and geolocation processes while minimizing resource consumption on user devices and the detection system.

In an embodiment, dynamic resource allocation component 323 monitors the computational load and battery levels of participating devices within the SEGNet. Based on these parameters, the component prioritizes certain tasks, such as geolocation computations or sensor data analysis, assigning them to devices with higher available resources. For example, if a device with significant computational capacity is part of the SEGNet, it may be designated to process time-difference-of-arrival (TDOA) calculations or aggregate multi-device data, reducing the workload on less capable devices.

Dynamic resource allocation component 323 employs adaptive scheduling algorithms to optimize CPU usage during event detection. For instance, in scenarios where sensor fusion or event validation tasks generate spikes in computational demand, the component schedules these tasks during periods of lower overall system activity. The component may also throttle non-critical processes to ensure uninterrupted execution of high-priority event detection functions.

In certain configurations, dynamic resource allocation component 323 integrates with SEGNet formation and management component 310 to evaluate the resource profiles of candidate devices before their inclusion in the SEGNet. Devices with low battery levels or limited processing capabilities may be excluded or assigned secondary roles, such as data relay or auxiliary sensing.

Dynamic resource allocation component 323 interacts with sensor fusion component 210 and event validation component 325 to balance resource allocation during multi-sensor data aggregation and event confirmation processes. For example, dynamic resource allocation component 323 may reduce the sampling rates of non-primary sensors or selectively enable specific fusion algorithms based on real-time resource availability. Additionally, during SEGNet inactivity, the component may limit processing to low-power detection methods, such as CFAR thresholds, conserving resources until a high-confidence EOI is detected.

In various embodiments, dynamic resource allocation component 323 communicates with machine learning system interface 304 to retrieve optimized operational parameters, such as adjusted detection thresholds or reduced model complexity, ensuring resource-efficient processing while maintaining detection accuracy. For example, a lightweight machine learning model may be deployed on devices with limited resources, while more complex models are assigned to high-capacity systems.

Dynamic resource allocation component 323 integrates with various components to dynamically allocate resources for geolocation tasks. For instance, it may prioritize TDOA or AoA calculations on devices with superior synchronization accuracy or sensor performance, ensuring efficient and reliable geolocation results. Furthermore, during distributed geolocation processing, dynamic resource allocation component 323 evaluates the workload distribution, offloading computationally intensive tasks to detection system 132 when participating devices face resource constraints.

Dynamic resource allocation component 323 monitors network conditions to adapt communication strategies based on resource availability and operational priorities. For example, when devices are in close proximity, the component prioritizes low-energy communication protocols, such as Wi-Fi Direct or Bluetooth, to minimize battery drain. Conversely, in scenarios requiring extended communication range or higher bandwidth, the component transitions to higher-power protocols, such as 5G or cellular networks.

In certain embodiments, dynamic resource allocation component 323 leverages machine learning models trained to predict resource usage trends under various operating conditions. These models assist in dynamically adjusting sampling rates, communication bandwidths, and computational task allocations, ensuring that SEGNet remains operational under diverse environmental and resource constraints.

By continuously adapting resource allocation based on real-time operational conditions and system demands, dynamic resource allocation component 323 ensures sustainable and efficient SEGNet performance while minimizing the impact on participating devices.

Event validation component 325 is operable to confirm and validate Events of Interest (EOIs) detected within Spontaneously Emergent Geolocation Networks (SEGNets) by leveraging multi-sensor data and applying validation techniques. This component ensures that EOIs identified by distributed geolocation processing component 312 and event identification component 316 meet predefined reliability criteria before proceeding to geolocation or notification stages.

More specifically, event validation component 325 aggregates sensor data, such as audio recordings, accelerometer readings, barometric pressure changes, and timestamp information, from participating devices within the SEGNet. It applies a set of validation algorithms designed to cross-check and correlate the data against known EOI patterns or thresholds. For example, the component may compute statistical measures such as signal-to-noise ratio (SNR) or cross-correlation values between audio data and motion sensor data to evaluate the likelihood that the detected event is valid.

In certain embodiments, event validation component 325 incorporates machine learning models trained to distinguish genuine EOIs from false positives. These models may utilize feature vectors derived from multi-sensor data, such as frequency-domain characteristics of audio signals and principal components of motion data, to classify events with high accuracy. For instance, a neural network-based classifier may process incoming data streams and assign confidence scores to detected events, enabling the system to filter out noise or irrelevant signals effectively.

Event validation component 325 also interfaces with consensus component 314 to incorporate input from multiple devices in the SEGNet. By analyzing data consistency and agreement across devices, the component verifies whether the detection aligns with expected spatiotemporal patterns for the EOI. In cases where inconsistencies or anomalies are detected, the component may flag the event for further analysis or reject it outright.

Event validation component 325 employs signal processing techniques to enhance validation accuracy. For instance, it may use frequency-domain analysis, such as spectrogram comparison, to identify characteristic audio patterns associated with specific EOIs. Additionally, the component applies statistical models to evaluate the likelihood of an EOI based on spatial and temporal correlations among sensor data streams.

To reduce resource consumption, event validation component 325 prioritizes high-confidence detections for immediate validation while queuing lower-confidence detections for further analysis. For instance, events with strong sensor correlations and high signal-to-noise ratios are processed immediately, while those with weaker signals are subjected to additional cross-validation with data from detection system 132.

Event validation component 325 interacts with machine learning system interface 304 to periodically update its models and validation thresholds based on feedback from machine learning system 136. This iterative learning process ensures that the component adapts to new event types, environmental conditions, and sensor capabilities, maintaining robust validation performance over time.

In certain embodiments, event validation component 325 operates in conjunction with dynamic resource allocation component 323 to balance validation accuracy and resource consumption. For example, when system resources are constrained, the component may reduce the complexity of its validation algorithms or rely on pre-validated sensor data from detection system 132. Conversely, during periods of high resource availability, the component may employ more computationally intensive techniques to improve validation precision.

In various embodiments, event validation component 325 applies dynamic thresholds or contextual adjustments to enhance validation accuracy in varying environments. For instance, in noisy urban settings, the component may adapt its validation criteria to account for higher background noise levels, reducing the likelihood of false positives. Similarly, the component can integrate feedback from machine learning system 136 to refine its validation processes over time, incorporating newly identified event patterns or updated thresholds.

In certain configurations, event validation component 325 logs validation outcomes in event data store 232 for future analysis and system improvement. This enables the detection system to maintain an auditable record of its decision-making processes and supports iterative refinement of detection and validation methodologies. In certain embodiments, iterative refinement involves integrating additional sensor data from devices dynamically added to the network after an initial geolocation estimate. The refinement process includes recalibrating geolocation parameters, such as time delay offsets or angle calculations, based on newly synchronized data. For example, a preliminary geolocation result derived from three devices may be updated when a fourth device with high-confidence data joins the network, improving accuracy and reducing uncertainty in the final geolocation output.

Sensor data store 230 is operable to store raw and preprocessed sensor data collected from participating devices within the Spontaneously Emergent Geolocation Network (SEGNet). More specifically, Sensor data store 230 manages data streams such as audio signals, accelerometer readings, gyroscope measurements, magnetometer data, barometric pressure, and timestamped geolocation coordinates. This data store provides a centralized repository for handling the high-frequency sensor inputs necessary for real-time and batch processing tasks performed by detection system 132.

For example, Sensor data store 230 organizes sensor data in a structured format that allows efficient querying and retrieval. The data may be indexed by attributes such as device ID, sensor type, timestamp, or geographic region to facilitate streamlined access by system components, including distributed geolocation processing component 312 and event validation component 325. In certain embodiments, Sensor data store 230 implements compression algorithms to reduce storage overhead, particularly for large datasets such as high-resolution audio files.

In various configurations, Sensor data store 230 integrates with sensor data interface 302 to ensure seamless ingestion of data from SEGNet devices. The store also supports synchronization mechanisms to align data from multiple sensors and devices, ensuring temporal consistency for tasks such as TDOA and AoA calculations. Once processed, data in Sensor data store 230 may be archived or transferred to event data store 232 for further analysis and validation.

Event data store 232 is operable to manage and store validated event-related data generated during the detection and geolocation processes. More specifically, event data store 232 records information such as event classifications, geolocation estimates, consensus metrics, and timestamps for confirmed Events of Interest (EOIs). This data store serves as a central repository for event metadata, supporting downstream processes such as reporting, notification, and model training.

For instance, event data store 232 associates validated EOIs with supporting sensor data, enabling a detailed record of the detection and validation processes. This association allows for comprehensive post-event analysis and facilitates the generation of historical datasets for improving machine learning models. In certain embodiments, event data store 232 supports distributed access, allowing other system components, such as machine learning system 136, to retrieve data for model refinement.

In various configurations, event data store 232 applies version control mechanisms to track updates or revisions to event data. For example, if additional analysis modifies the geolocation estimate of an EOI, the updated record is stored while preserving the original entry for audit purposes. Event data store 232 interfaces with both event identification component 316 and location detector 318 to maintain consistency across the detection pipeline.

Geolocation data store 334 is operable to store location-specific data generated during the geolocation process. More specifically, this data store records results from TDOA and AoA calculations performed by location detector 318, along with supplementary metadata such as accuracy metrics, device positions, and environmental factors. Geolocation data store 334 ensures that spatial data is readily available for system components requiring geolocation inputs, such as notification system interface 306 or external system interface 308.

For example, geolocation data store 334 maintains a structured schema for organizing geolocation results by event ID, timestamp, and geographic region. This schema supports efficient querying for real-time notification and reporting purposes. In certain embodiments, the data store incorporates spatial indexing techniques to optimize retrieval performance, particularly for large-scale networks with high event densities.

In various configurations, geolocation data store 334 integrates with distributed geolocation processing component 312 and consensus component 314 to ensure that only validated and high-confidence geolocation results are stored. The data store may also support cross-referencing with historical data store 236 to identify patterns or trends in event locations over time.

Historical data store 236 is operable to archive long-term records of system activity, including validated EOIs, geolocation results, and associated sensor data. More specifically, historical data store 236 provides a repository for retrospective analysis, model training, and system performance evaluation. This data store supports the iterative refinement of detection algorithms and geolocation methodologies by preserving a comprehensive record of past events and system operations.

For example, historical data store 236 enables system administrators to analyze trends in event detections, such as recurring patterns in geographic hotspots or changes in detection accuracy over time. In certain embodiments, this data store supports machine learning applications by providing training datasets for developing or updating detection models. Historical data store 236 interfaces with machine learning system interface 304 to facilitate this functionality.

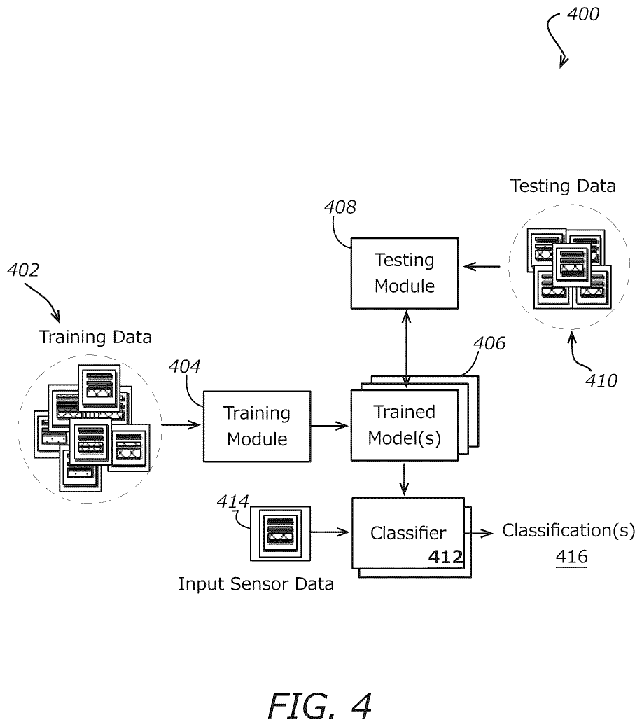

In various configurations, historical data store 236 incorporates redundancy and backup mechanisms to ensure data integrity and availability. The store may also include anonymization features to protect sensitive user data while maintaining the utility of the dataset for analysis. Additionally, historical data store 236 may support integration with external systems via external system interface 308, enabling cross-system comparisons or collaborative research initiatives. FIG. 4 illustrates an exemplary neural network training pipeline 400 for detecting, classifying, and geolocating Events of Interest (EOIs) based on sensor data from participating devices, in accordance with various embodiments. In this example, a set of training data 402 is collected from relevant sources to train machine learning models 406, optimized for EOI detection, classification, and geolocation.

Training data 402 includes structured and unstructured sensor data, such as audio waveforms, accelerometer readings, GPS timestamps, and barometric pressure variations. This data is annotated to include EOI classifications and associated geolocation parameters. For example, audio data may be labeled as gunshot or non-gunshot, along with its time and location of occurrence. In certain embodiments, training data 402 is supplemented with synthetic data generated through augmentation techniques, such as adding simulated noise or scaling sensor values, to improve model robustness against environmental variability.

In various embodiments, training data 402 undergoes preprocessing in training module 404 to align disparate sensor data formats, resample data rates, and standardize features. Preprocessing may involve techniques such as Dynamic Time Warping (DTW) to align time-series data from different sensors, Principal Component Analysis (PCA) to reduce dimensionality and extract key features, and signal normalization to account for sensor-specific variations. Training module 404 uses supervised learning techniques to train machine learning models 406 to recognize EOIs under varying environmental conditions and sensor noise profiles.

Machine learning models 406 include lightweight Convolutional Neural Networks (CNNs) for edge processing and more advanced architectures, such as Long Short-Term Memory (LSTM) networks or Transformer networks, for server-based computations. The models are trained to integrate sensor data and refine EOI detection algorithms like Constant False Alarm Rate (CFAR). In some embodiments, Encoder Neural Networks (ENNs) are used to transform sensor data into a common feature space, enabling seamless integration of data from multiple sensor modalities, such as audio and accelerometer readings.

After training, the models are evaluated using a separate testing module 408 with testing data 410. Testing data 410 includes previously unseen sensor recordings to assess model performance metrics, such as accuracy, recall, and false positive rate. For instance, the testing phase may involve analyzing a subset of audio data with known event labels, comparing model predictions against ground truth classifications. If performance thresholds are met, the trained models are deployed for real-time classification in classifier module 412.

Classifier module 412 processes incoming sensor data 414 to detect EOIs and output classifications 416, including event type and geolocation estimates. For example, a model may classify an audio sample as a gunshot and assign geolocation coordinates based on Time Difference of Arrival (TDOA) and/or Angle of Arrival (AoA) analysis. In certain embodiments, classifier module 412 incorporates additional geolocation methods, such as Frequency Difference of Arrival (FDOA) or statistical error correction, to refine location estimates further.

Neural network training pipeline 400 supports iterative learning, with new data continuously refining model accuracy. Feedback from detection system 132, including real-world sensor data and operational outcomes, is incorporated into subsequent training cycles to enhance model adaptability. The system also adapts to deployment environments, leveraging edge configurations for localized processing or cloud-based configurations for high-complexity tasks requiring server-level computation.

In certain embodiments, this pipeline integrates unsupervised learning techniques, such as clustering, to uncover patterns in unlabeled data. For instance, clustering may group sensor events with similar temporal or spatial characteristics, facilitating the discovery of new EOI patterns. Additionally, neural network training pipeline 400 incorporates mechanisms to monitor model performance metrics in real time, enabling dynamic adjustments to model parameters or retraining when performance degradation is detected.

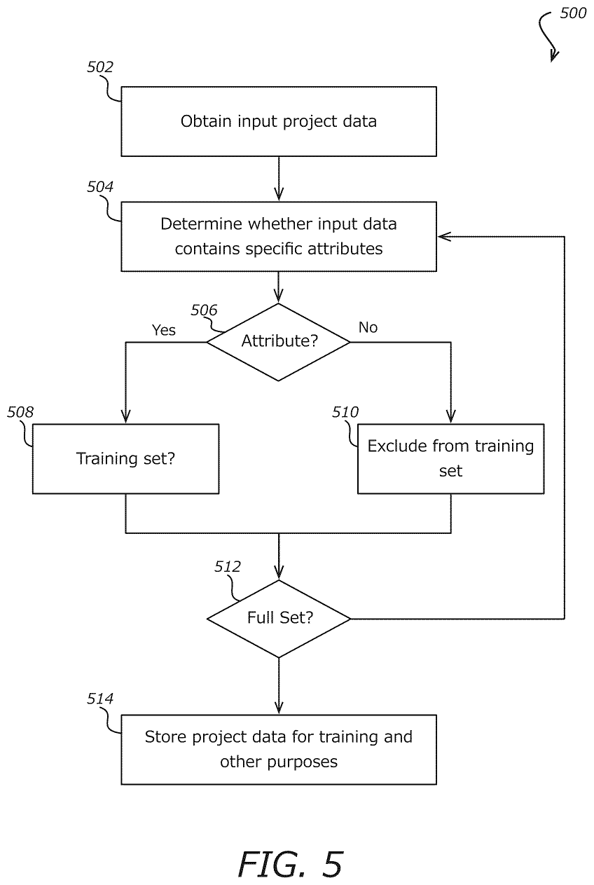

FIG. 5 illustrates an example process 500 for determining and refining training data utilized to improve machine learning models in accordance with various embodiments. In an embodiment, this process is implemented within machine learning system 136 to enable accurate event detection, classification, and geolocation. These models are subsequently deployed to enhance components such as listening threshold component 214, event detector component 216, event localization component 221, sensor fusion component 210, distributed geolocation processing component 312, consensus component 314, dynamic resource allocation component 323, and event validation component 325, enabling precise detection, classification, and geolocation of events in real-world scenarios.

The process begins at step 502, where input data is collected from various sources, including Sensor data store 230, event data store 232, geolocation data store 334, and historical data store 236, as well as corresponding data stores in detection system 132. This input data may include raw sensor outputs, such as audio waveforms, accelerometer readings, gyroscopic data, timestamped event logs, and geolocation coordinates. In certain embodiments, metadata associated with prior detections, such as environmental noise levels or device-specific parameters, is also collected. For instance, geolocation data may incorporate TDOA measurements from SEGNet devices, while audio data may include waveforms with annotated EOI classifications.

At step 504, the collected input data is analyzed to determine whether it contains specific attributes necessary for training machine learning models. This analysis may involve evaluating the data for features indicative of EOIs, such as signal-to-noise ratios, frequency patterns, or spatial correlations. For example, accelerometer readings may be assessed for sudden movements indicative of shockwaves, while barometric pressure variations are analyzed for events associated with atmospheric disturbances.

A determination is made at step 506 regarding whether the analyzed input data exhibits the relevant attributes for inclusion in the training set. If the input data meets the criteria, it is tagged and incorporated into the training dataset at step 508. For example, audio data with high signal clarity may be labeled with event classifications, such as “gunshot” or “explosion,” and associated with geolocation metadata. Conversely, data that lacks sufficient clarity, such as inconclusive sensor readings or false positives, is excluded at step 510 to maintain dataset quality. Excluded data may be archived for future analysis or enhancement.

At step 512, the system evaluates whether the assembled training set meets predefined criteria for completeness. These criteria may include achieving a minimum number of data samples, ensuring diversity in sensor types and event categories, or meeting thresholds for geospatial coverage. If the criteria are satisfied, the finalized training dataset is stored at step 514 for use in training machine learning models. Otherwise, the process loops back to step 502, where additional data is collected and evaluated until the training set is complete or a stop condition is triggered.

In accordance with various embodiments, the trained machine learning models generated through the processes described in FIG. 5 are utilized across detection system 132 and detection application 131 to enhance overall system performance. Sensor fusion component 210 employs these models to integrate data from multiple sensors, improving detection accuracy by identifying cross-sensor correlations. Distributed geolocation processing component 312 applies the models to refine TDOA and AoA calculations, ensuring precise geolocation even in noisy environments. Consensus component 314 leverages these models to evaluate device agreement within SEGNet, ensuring reliable data aggregation and validation. Dynamic resource allocation component 323 uses the models to predict system resource utilization, enabling efficient allocation of CPU, battery, and sensor usage. Event validation component 325 applies these models to confirm event likelihoods based on learned patterns, reducing false positives and enhancing system reliability.

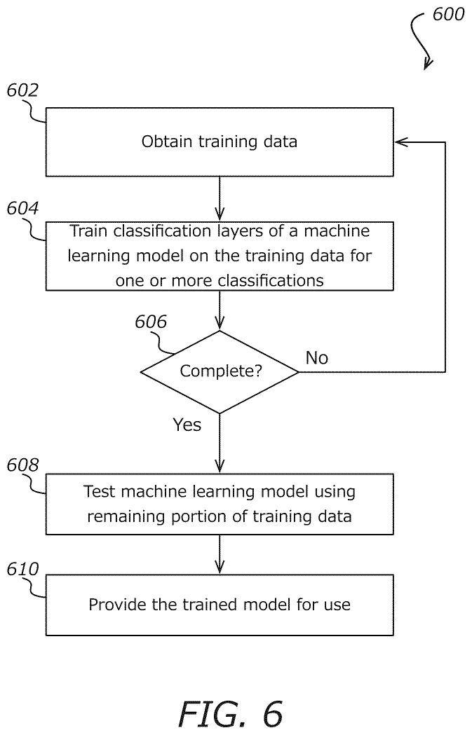

FIG. 6 illustrates an example process 600 for training a machine learning model in accordance with various embodiments. This process is implemented within machine learning system 136 to improve the accuracy and reliability of event detection, classification, and geolocation across Spontaneously Emergent Geolocation Networks (SEGNets). The trained models are subsequently deployed to enhance components such as listening threshold component 214, event detector component 216, event localization component 221, and other relevant components within detection application 131 and detection system 132.

The process begins at step 602, where the system collects a set of training data from sources such as Sensor data store 230, event data store 232, geolocation data store 334, and historical data store 236. Additionally, training data may be obtained from corresponding data stores within detection system 132 to ensure comprehensive coverage. This training data includes labeled sensor outputs, timestamped event logs, geolocation coordinates, and metadata associated with prior detections. For instance, annotated datasets may include audio waveforms labeled as gunshots or explosions, accelerometer readings indicating sudden motion, or barometric pressure variations associated with environmental disturbances.

At step 604, the collected training data is used to train the machine learning model. During this phase, the model adjusts its internal parameters, such as neural network weights, to optimize its ability to detect, classify, and geolocate EOIs. Training techniques may include supervised learning with labeled datasets, reinforcement learning to fine-tune decision-making, or hybrid approaches. For example, the model may learn to differentiate between overlapping sensor signals, enhancing its ability to perform TDOA and AoA calculations under noisy or complex conditions.

At step 606, the system evaluates whether the training process is complete or a predefined stop condition is met. Stop conditions may include achieving a target accuracy threshold, processing the entire dataset, or reaching a performance benchmark. If the stop condition is not met, the process loops back to step 602 to collect additional training data or refine the training parameters. This iterative approach ensures the model continues to improve through successive cycles, adapting to new data and scenarios.

If the stop condition is satisfied, the process proceeds to step 608, where the trained model undergoes a testing phase. During this phase, a reserved testing dataset, separate from the training data, is used to evaluate the model's performance in detecting, classifying, and geolocating EOIs. For example, the model may process testing data that includes known event signatures, such as audio recordings of gunshots with precise geolocation tags, and compare its outputs to ground truth labels. This evaluation assesses the model's accuracy, precision, recall, and robustness under varying conditions.

At step 610, if the model successfully passes the testing phase and meets predefined accuracy and reliability criteria, it is finalized and deployed for operational use. The trained model is integrated into detection application 131 and detection system 132, where it enhances real-time event detection, classification, and geolocation capabilities. For example, the trained model may improve the sensitivity of event detector component 216 for identifying EOIs, support distributed geolocation processing component 312 in refining geolocation estimates under noisy environments, or assist event validation component 325 in confirming event likelihoods.

In accordance with various embodiments, the machine learning models trained through the process described in FIG. 6 are continuously refined through iterative learning cycles. For example, feedback from detection system 132 and detection application 131 can be incorporated to adapt the models to evolving environmental conditions, sensor noise profiles, or emerging EOI types.

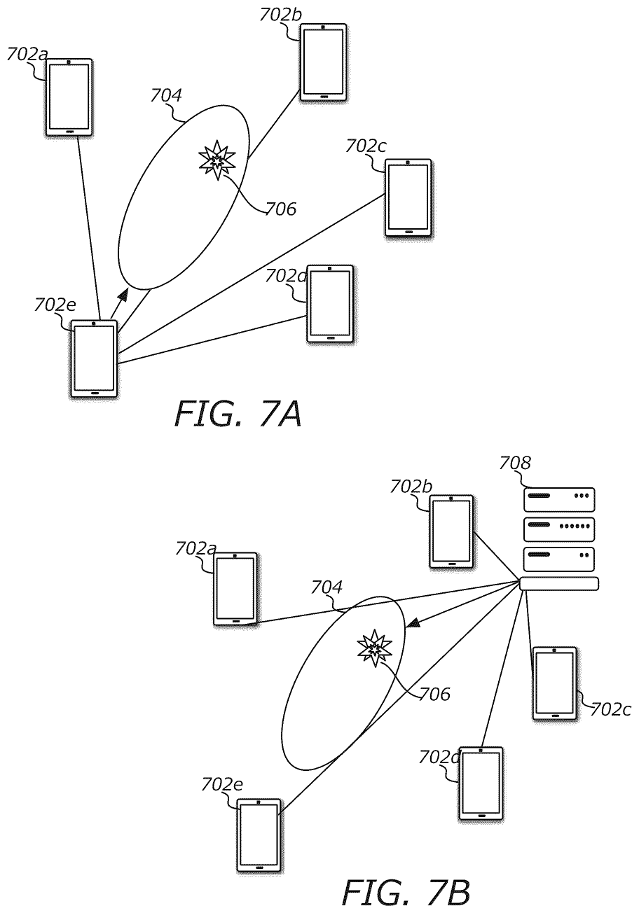

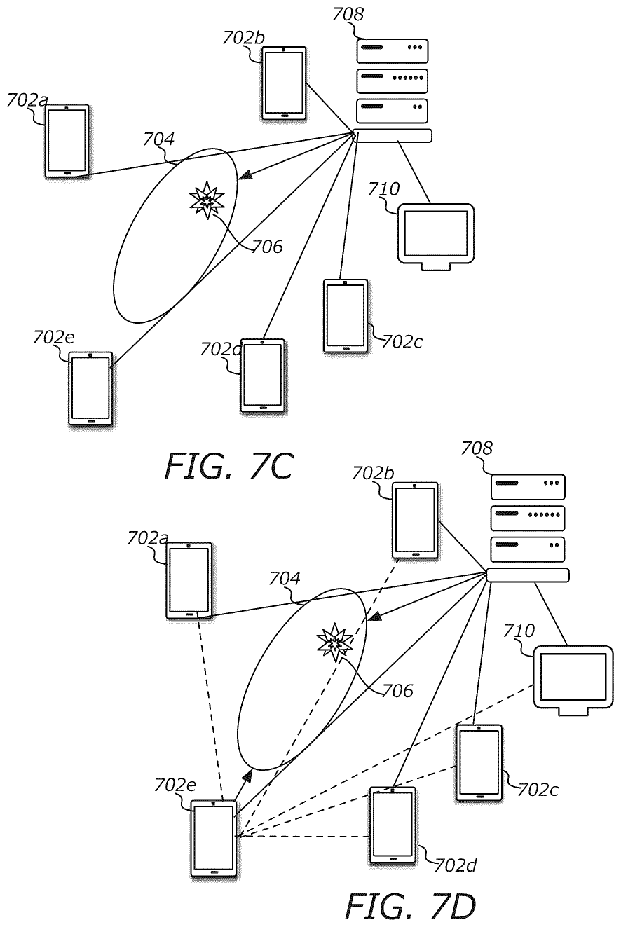

FIG. 7A illustrates an example configuration for Network-Based Geolocation Processing within a Spontaneously Emergent Geolocation Network (SEGNet), where geolocation estimation occurs locally on a primary participating device, in accordance with various embodiments.

In an embodiment, devices 702a-702e can participate in a SEGNet and may include smartphones, stand-alone specialized devices, or a combination thereof. The stand-alone specialized devices can be pre-installed at specified geo-locations and designed to detect and process acoustic signals associated with firearms or other sound-based events. These devices may include, but are not limited to, acoustic sensors, microphones, video cameras, infrared sensors, and digital signal processors. In certain configurations, the stand-alone devices may also include network connectivity modules for communication with other SEGNet devices, security cameras, or centralized servers. When connected to security cameras, these devices may utilize image recognition algorithms to detect firearms in video feeds and correlate such information with acoustic data for improved detection accuracy.

Each device (e.g., device 702a, device 702b, device 702c, device 702d, and device 702c) runs detection application 131 (see FIG. 2), enabling them to monitor and identify potential Events of Interest (EOIs). For example, smartphones within the SEGNet may detect the sound of a gunshot using their built-in sensors, while stand-alone specialized devices provide additional monitoring and sensor capabilities from fixed locations, such as urban areas, streets, or parks. Upon detecting the EOI 706, the lead device 702e initiates SEGNet formation by transmitting sensor data, such as raw audio, timestamp information, geolocation coordinates, and metadata, to nearby devices 702a-702d over available communication channels, including 5G, Wi-Fi, Bluetooth, or similar networking protocols.

Device 702e is designated as the primary device based on criteria such as its proximity to the EOI 706, resource availability, or network connectivity. This designation is determined by SEGNet formation and management component 310 (see FIG. 3). As the lead device, device 702e aggregates sensor data from devices 702a-702d and performs geolocation estimation tasks.

Geolocation information 704 can represent the area generated by the primary device 702e after performing data aggregation and geolocation estimation. The arrow from device 702c to geolocation output 704 indicates the data flow and processing completed by the primary device. The geolocation information 704 identifies the likely region or coordinates of the EOI 706.

The sensor data aggregation and geolocation estimation processes involve components such as sensor data aggregator 218 and event localization component 221 (see FIG. 2), which operate within detection application 131 on device 702e. These components execute Time Difference of Arrival (TDOA) calculations, Angle of Arrival (AoA) estimations, and cross-device sensor data correlation to determine the geolocation of the EOI. TDOA and AoA techniques rely on the known geolocations of the participating devices and sensor measurements to compute the geolocation of the EOI.

After computing the geolocation estimate, device 702e (the primary device) disseminates the resulting geolocation information 704 to other participating devices in the SEGNet (e.g., (device 702a, device 702b, device 702c, device 702d, and device 702c) for confirmation and coordination. In certain embodiments, device 702e may also relay the geolocation information to interested third parties, such as first responders, law enforcement, or site supervisors, through notification system interface 306 or external system interface 308 (see FIG. 3). For instance, the geolocation data may be shared in real-time with emergency response teams in critical event scenarios, such as gunshots or explosions.

This configuration demonstrates the ability of the SEGNet to function in a decentralized manner, leveraging edge-based processing on the primary device 702e to ensure efficient event detection, geolocation, and dissemination of information.

FIG. 7B illustrates an exemplary network architecture for server-based geolocation processing in accordance with various embodiments. In this configuration, a collection of smartphones (device 702a, device 702b, device 702c, device 702d, and device 702c) detect an event of interest (EOI) 706 and transmit sensor data to detection server 708 for centralized processing.

In an embodiment, each smartphone device (device 702a, device 702b, device 702c, device 702d, and device 702e) executes detection application 131 (see FIG. 2), which monitors for potential EOIs. Upon detecting EOI 706, the participating devices collect sensor data, including raw audio, geolocation coordinates, timestamped events, and environmental metadata. These devices establish a communication link with detection server 708, utilizing network protocols such as 5G, LTE, Wi-Fi, or other internet-based protocols to ensure efficient data transfer.

The detection server 708, representative of detection system 132 (see FIG. 3), serves as the central processing unit for analyzing and geolocating EOIs based on aggregated sensor data. After receiving the transmitted data from participating devices, detection server 708 performs advanced computations, including time-difference-of-arrival (TDOA) and angle-of-arrival (AoA) analysis. These computations are supported by distributed geolocation processing component 312, event validation component 325, and machine learning system 136, as described in FIG. 3 and FIG. 6.

The server-generated geolocation estimate, indicated as element 704, represents the processed output derived from the aggregated and analyzed sensor data. For instance, detection server 708 refines the geolocation estimate by correlating signals across devices and applying machine learning models trained for event classification and geolocation (as described in FIG. 5 and FIG. 6). The resulting geolocation information includes precise coordinates, confidence intervals, and any additional contextual metadata.

Once detection server 708 finalizes the geolocation output, it disseminates the results back to the participating devices in the SEGNet (device 702a, device 702b, device 702c, device 702d, and device 702e) and to relevant third parties through interfaces such as notification system interface 306 or external system interface 308 (see FIG. 3). In an emergency scenario, this geolocation information may be shared with first responders, law enforcement, or supervisors for timely response and action. Additionally, detection server 708 may archive this data for further analysis, leveraging components such as event data store 232 and geolocation data store 334.

The architecture depicted in FIG. 7B highlights the collaboration between smartphones (e.g., device 702a, device 702b, device 702c, device 702d, and device 702e) and detection server 708. While the participating devices detect and initiate the EOI, the server offloads computationally intensive tasks, ensuring optimized resource utilization across the network. This configuration is particularly advantageous in scenarios involving complex geolocation tasks or high volumes of sensor data.

FIG. 7C illustrates server-based geolocation processing with an external desktop interface, showcasing the integration of Spontaneously Emergent Geolocation Networks (SEGNets) with centralized servers and desktop systems for enhanced situational awareness, in accordance with various embodiments.

Similar to the process in FIG. 7B, mobile devices 702a-702e detect an Event of Interest (EOI) 706 using detection application 131 (see FIG. 2). Upon detecting the EOI, the primary device 702e initiates the SEGNet by aggregating sensor data from nearby devices 702a-702d, including audio recordings, timestamped data, geolocation coordinates, and metadata. This data is transmitted to detection server 708 for centralized processing through available communication networks such as 5G, Wi-Fi, or other suitable protocols. The selection of device 702e as the primary device can be based on factors such as proximity to EOI 706, computational resources, and network connectivity.

Detection server 708 performs advanced geolocation computations by leveraging TDOA and AoA algorithms, neural network models trained on diverse datasets (see FIGS. 4-6), and other geospatial processing techniques. The server consolidates sensor data, applies machine learning models, and generates a geolocation estimate ellipse representing the probable location of the EOI. This process may involve distributed geolocation processing component 312, event validation component 325, and consensus component 314 (see FIG. 3) to ensure accurate and reliable geolocation results.

After computing the geolocation estimate, detection server 708 disseminates the results to both SEGNet devices and external systems. Participating devices 702a-702e receive the geolocation estimate, enabling enhanced situational awareness for users on-site. Concurrently, detection server 708 transmits the geolocation results to an external desktop interface 710. This desktop interface may provide real-time visualizations, event tracking, and data sharing capabilities for third-party entities such as emergency response teams, law enforcement, or operational supervisors.

The integration of desktop interface 710 facilitates broader system accessibility and situational awareness. For example, in a critical event scenario, the desktop interface could display the geolocation estimate ellipse over a map, provide access to aggregated sensor data, and offer communication tools to coordinate responses. Desktop interface 710 may interact with notification system 134 and external system interface 308 (see FIG. 3) to distribute geolocation data across relevant stakeholders.

FIG. 7D illustrates a hybrid geolocation processing framework in accordance with various embodiments, demonstrating distributed workload sharing between participating devices (e.g., device 702a, device 702b, device 702c, device 702d, and device 702e) and detection system 132, represented here as server 708. This configuration enables a flexible geolocation processing framework, where geolocation computations can be performed entirely on participating devices, on the server, or across a combination of both, depending on the system configuration and operational context.

Participating devices 702a-702e, each running detection application 131, are operable to monitor for Events of Interest (EOIs). Upon detecting EOI 706, the devices collaboratively form a Spontaneously Emergent Geolocation Network (SEGNet) under the coordination of SEGNet formation and management component 310 (see FIG. 3). In this hybrid geolocation model, sensor data, such as audio waveforms, GPS timestamps, and accelerometer readings, may be processed locally on participating devices or externally on detection system 132, depending on factors such as connectivity, computational load, and resource availability.

Local processing on participating devices 702a-702e is operable to preprocess and analyze sensor data, generating preliminary geolocation estimates through components such as sensor data aggregator 218 and event localization component 221 (see FIG. 2). These components facilitate tasks such as Time Difference of Arrival (TDOA), Angle of Arrival (AoA), and correlation analyses directly on the devices. Simultaneously or alternately, devices may transmit raw or partially processed data to detection system 132 for centralized geolocation computations. Detection system 132 may leverage its computational resources to execute more intensive algorithms, such as deep learning-based optimization or multi-layer consensus validation, to refine geolocation estimates and ensure system-wide consistency.

In accordance with various embodiments, the hybrid processing framework ensures seamless collaboration between the participating devices and detection system 132. For example, preliminary estimates computed by devices 702a-702e may be transmitted to server 708, where they are aggregated, validated, and further refined using advanced processing techniques within distributed geolocation processing component 312 and consensus component 314 (see FIG. 3). Conversely, server 708 may distribute updated geolocation estimates or additional computational tasks to the participating devices, leveraging the proximity and sensor diversity of the devices for more precise geolocation results.

In this framework, the processed geolocation output, represented as element 704, may include an estimated location of EOI 706, such as a geolocation ellipse or point. This output may be relayed to external systems, such as desktop interface 710, or disseminated to first responders and other third parties through notification system interface 306 or external system interface 308 (see FIG. 3). The system's hybrid design ensures that geolocation and EOI classification tasks are dynamically allocated between the devices and the server, optimizing resource usage and computational efficiency.

This hybrid configuration provides flexibility and scalability, allowing the SEGNet to adapt to a wide range of operational conditions. For example, in high-connectivity environments, server 708 may handle the majority of geolocation computations, with participating devices acting primarily as data sources. In contrast, in low-connectivity or resource-constrained scenarios, devices 702a-702e may autonomously perform geolocation computations, ensuring uninterrupted operation and geolocation accuracy.

The hybrid processing framework depicted in FIG. 7D supports geolocation and EOI classification capabilities across diverse environments, ranging from urban areas with dense device distributions to rural or remote locations with limited connectivity. By enabling adaptive workload sharing between participating devices and the server, the system ensures reliable and efficient geolocation processing under varying network and resource constraints.

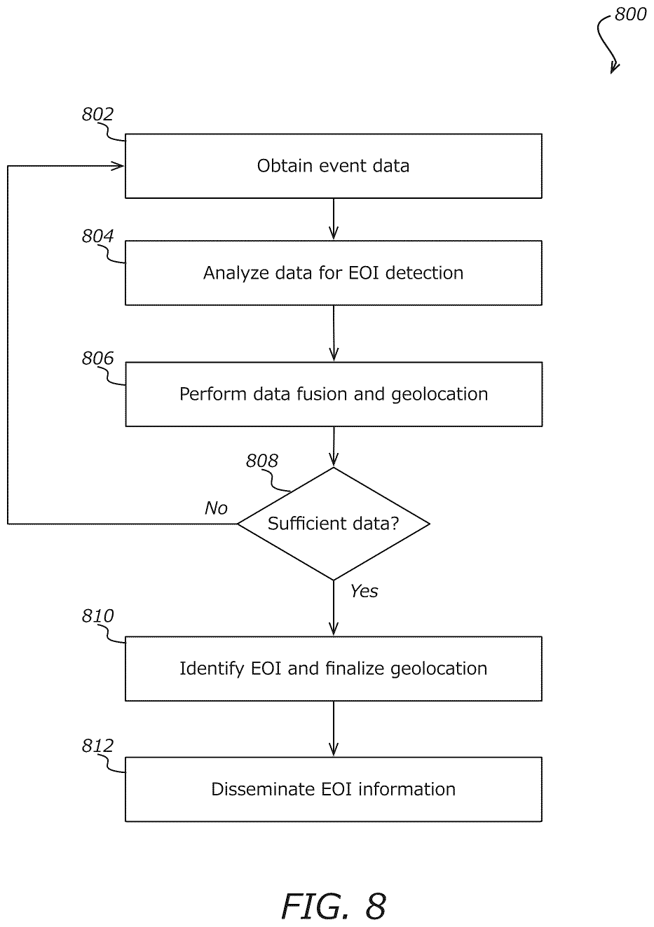

FIG. 8 illustrates an exemplary process 800 for detecting, identifying, and geolocating Events of Interest (EOIs) within a Spontaneously Emergent Geolocation Network (SEGNet) in accordance with various embodiments. The steps in this process may be performed by components within the SEGNet architecture, such as detection application 131, detection system 132, and other relevant components illustrated in FIGS. 1-7. The process may include additional steps, fewer steps, or variations in the sequence of steps without departing from the scope of the invention, as would be apparent to one of ordinary skill in the art.

At step 802, event data is obtained by a plurality of sensors across a plurality of participating devices within the SEGNet. The event data may include audio signals, accelerometer readings, barometric pressure variations, gyroscopic measurements, and other sensor outputs indicative of an EOI. These devices, such as smartphones or other mobile devices, may be distributed within a geographical area and equipped with compatible detection applications operable to gather multi-sensor data. In an embodiment, the event data includes timestamped raw data streams from each sensor, synchronized to a GPS-disciplined clock to enable cross-device temporal alignment.

At step 804, the event data is analyzed to identify whether an EOI has occurred, initiating SEGNet formation and activation. This analysis may involve pre-processing the data using methods such as filtering, resampling, or wavelet decomposition to isolate potential signals of interest. The analysis may also employ machine learning models or rule-based detection algorithms, such as a Constant False Alarm Rate (CFAR) detector, to identify patterns consistent with EOIs, such as gunshots or explosions. In certain embodiments, this step triggers SEGNet formation by designating participating devices and assigning roles based on proximity, resource availability, and signal quality.

At step 806, the participating devices perform distributed geolocation processing for the detected EOI. The process includes applying Time Difference of Arrival (TDOA), Angle of Arrival (AoA), or hybrid geolocation techniques to estimate the geolocation of the EOI. These techniques use the geolocations of the participating devices and sensor data to compute the EOI's location. Components such as sensor data aggregator 218, sensor fusion component 210, and event localization component 221 are operable to synchronize and process sensor data from the devices, resulting in an estimation of the EOI's location.

At decision step 808, the system evaluates whether sufficient data and participants are available for accurate geolocation and event confirmation. If the number of participants or the quality of the data is deemed insufficient, the process loops back to step 802 for additional data collection or refinement. In certain embodiments, this decision-making process involves consensus component 314, which validates the consistency and reliability of data contributed by SEGNet participants.

If sufficient data is available, the process proceeds to step 810, where the EOI is identified and its location is finalized. This step involves event classification, such as identifying the type of EOI (e.g., gunshot, explosion), and confirming its geolocation. Machine learning models, operating within event identification component 316, may perform these classifications, while event localization component 221 applies advanced geolocation algorithms to determine precise coordinates.

At step 812, the Event of Interest (EOI) and its geolocation data, e.g., event detection and geolocation results, are disseminated to authorized users, external systems, and relevant stakeholders. In certain embodiments, the event detection and geolocation result includes metadata elements such as the event type (e.g., gunshot, explosion), timestamp, geolocation coordinates, and a confidence level indicating the reliability of the detection. The confidence level may be derived from factors such as sensor agreement, signal-to-noise ratio, and environmental conditions. These results can be formatted for transmission to external systems, such as emergency response platforms or cloud-based storage for future analysis. This dissemination process is facilitated by components such as notification system interface 306 and external system interface 308, which ensure that the geolocation information is transmitted securely and promptly to the appropriate parties. These parties may include emergency responders, law enforcement agencies, site supervisors, or other predefined third parties, depending on the type of EOI and the context in which it occurred.

In an embodiment, dissemination involves generating real-time notifications that include critical details such as the geolocation coordinates, event type, timestamp, and additional metadata. For example, if the EOI is identified as a gunshot, the system may send an alert to local law enforcement, complete with geolocation coordinates and confidence scores derived from detection and classification algorithms. Similarly, if the EOI is related to industrial operations, the geolocation data may be forwarded to site supervisors or safety officers for immediate action.

In certain configurations, dissemination may also include generating visual representations of the EOI location, such as geolocation ellipses or heat maps, which are provided to desktop interfaces or mobile applications. For instance, a desktop interface may receive a geospatial visualization overlaying the EOI location on a map, enabling users to analyze the event's proximity to critical infrastructure or other relevant landmarks.

The system is further operable to archive the EOI data, including raw and processed sensor streams, geolocation coordinates, and metadata, in geolocation data store 334. This archived data serves multiple purposes, including auditing, compliance validation, and post-event analysis. For example, historical EOI data can be reviewed to identify patterns, validate geolocation accuracy, or refine detection thresholds in future deployments.

In certain embodiments, the dissemination process includes an optional feedback loop, where newly collected and processed EOI data is transmitted to machine learning system 136 for model refinement. By leveraging this iterative learning approach, the system continuously improves its detection and geolocation algorithms, enhancing performance over time. For instance, data from a false-positive detection might be used to retrain the machine learning models, reducing the likelihood of similar errors in future operations.

In an embodiment, this process supports iterative learning and continuous optimization. New event data, once processed, may be fed back into the machine learning system 136 for model refinement, improving detection accuracy and geolocation precision over time. In certain embodiments, iterative refinement involves integrating additional sensor data from devices dynamically added to the network after an initial geolocation estimate. The refinement process includes recalibrating geolocation parameters, such as time delay offsets or angle calculations, based on newly synchronized data. For example, a preliminary geolocation result derived from three devices may be updated when a fourth device with high-confidence data joins the network, improving accuracy and reducing uncertainty in the final geolocation output. Furthermore, the SEGNet dynamically adapts to environmental and operational conditions, ensuring robust performance across diverse scenarios.

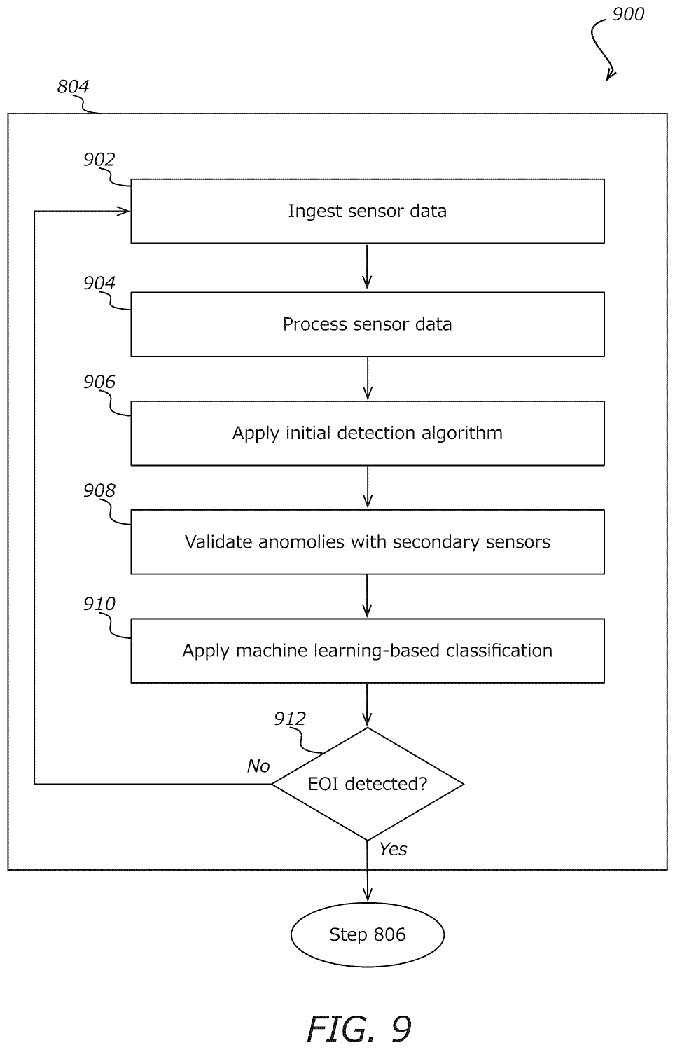

FIG. 9 illustrates an exemplary process 900 for analyzing data to detect an Event of Interest (EOI), corresponding to step 804 in FIG. 8, within a distributed geolocation and event detection system in accordance with various embodiments. This process involves leveraging sensor data collected from participating devices and applying multiple layers of analysis, including initial detection algorithms, secondary validation, and machine learning-based classification. The steps may be performed by components described in FIG. 1, FIG. 2, and FIG. 3, or in association with similar systems and components. The process may include additional steps, fewer steps, and/or a different sequence of steps without departing from the scope of the invention, as would be apparent to one of ordinary skill in the art.

At step 902, sensor data is ingested from participating devices within the Spontaneously Emergent Geolocation Network (SEGNet). This data may include audio signals, accelerometer readings, gyroscope outputs, and barometric pressure measurements, along with corresponding metadata, such as GPS timestamps and device identifiers. In an embodiment, the sensor data aggregator 218 synchronizes and preprocesses the incoming data streams to ensure temporal alignment and data consistency.

At step 904, the ingested sensor data is processed to remove noise and artifacts, enhancing its suitability for event detection. In one embodiment, preprocessing techniques, such as dynamic time warping (DTW) for temporal alignment and wavelet transforms for signal decomposition, are applied to the data. Additionally, sensor-specific filtering techniques, such as Kalman filtering for accelerometer data and frequency-domain filtering for audio signals, are used to reduce environmental interference and device-specific anomalies.

At step 906, an initial detection algorithm is applied to the processed data to identify potential anomalies indicative of an EOI. For example, Constant False Alarm Rate (CFAR) detector 219 may analyze audio data for frequency spikes characteristic of gunshots, while accelerometer data may be evaluated for sudden motion changes indicative of an impact event. This step prioritizes computational efficiency to quickly identify candidate events for further validation.

At step 908, the system validates anomalies detected in step 908 using secondary sensors. For instance, if an audio anomaly is identified, the system may analyze accelerometer and barometer data to confirm or refute the presence of an EOI. This multi-sensor validation process reduces false positives and enhances the reliability of event detection. In an embodiment, the system leverages mutual information analysis to quantify the correlation between sensor streams and determine the likelihood of an EOI.

At step 910, the validated data is subjected to machine learning-based classification to confirm the EOI type. Trained model 215, which may include neural networks or other machine learning models, analyzes the validated data for patterns consistent with specific EOIs, such as explosions or structural collapses. In various embodiments, the trained model integrates multimodal data inputs, including audio waveforms, accelerometer readings, and barometric pressure measurements. These inputs are preprocessed to enhance signal clarity, with techniques such as dynamic time warping for temporal alignment and wavelet transforms for signal decomposition. The model identifies cross-modal patterns, such as sudden audio spikes coupled with accelerometer shifts, to classify events like explosions or structural collapses accurately. The model is operable to dynamically adjust detection thresholds based on environmental conditions and sensor noise profiles, improving classification accuracy across diverse scenarios. At step 912, a decision point is reached to determine whether the analyzed data satisfies the criteria for EOI detection. If the data meets the criteria (following the “Yes” path), the process proceeds to subsequent steps, such as geolocation and classification, as described in FIG. 8. If the criteria are not met (following the “No” path), the process loops back to step 902 for additional data ingestion and analysis, ensuring comprehensive event detection.

In accordance with various embodiments, the process described in FIG. 9 integrates with other system components, such as listening threshold component 214 and sensor fusion component 210, to ensure robust and efficient event detection. For instance, listening threshold component 214 dynamically adjusts detection thresholds based on feedback from machine learning system 136, while sensor fusion component 210 correlates data across multiple sensors to enhance detection reliability.

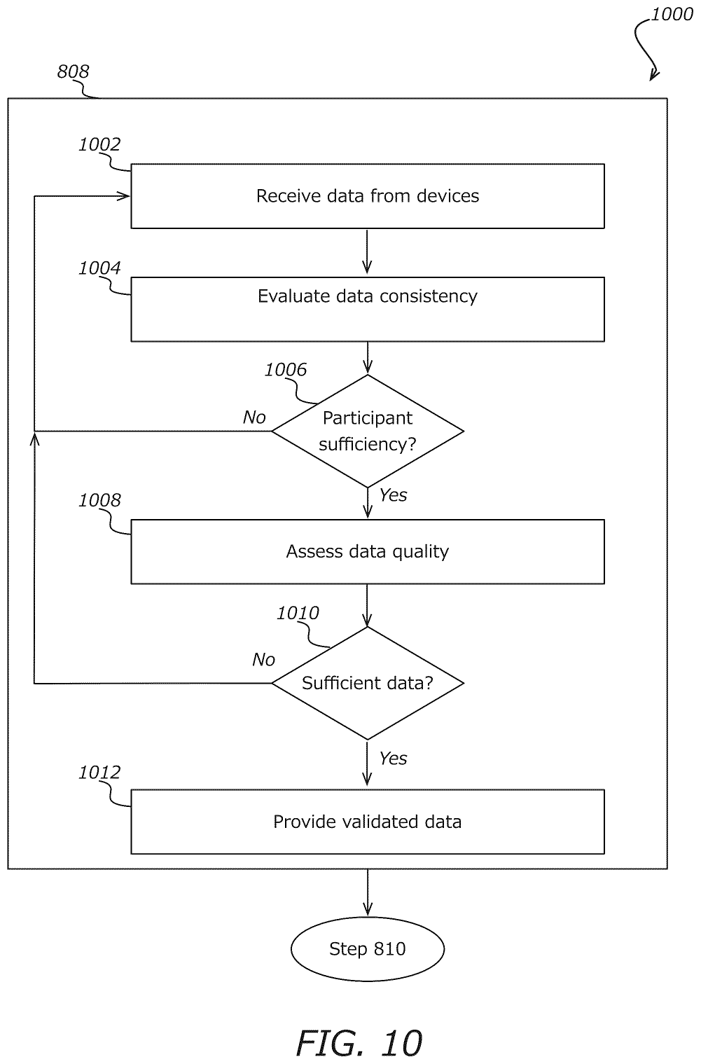

FIG. 10 illustrates an exemplary process 1000 for validating data sufficiency within a Spontaneously Emergent Geolocation Network (SEGNet), corresponding to Step 808 in FIG. 8, in accordance with various embodiments. More specifically, the process evaluates whether the collected data from participating devices is sufficient to proceed with geolocation and event classification tasks. The sufficiency validation considers factors such as data quality, participant count, and consistency among sensor streams, ensuring robust and reliable geolocation results.

The steps in this process may be performed by SEGNet formation and management component 310, consensus component 314, and other relevant system components. The process may include additional steps, fewer steps, and/or a different order of steps, without departing from the scope of the invention, as would be apparent to one of ordinary skill in the art.

At step 1002, the system receives event-related data from participating devices in the SEGNet. This data includes sensor streams such as audio signals, accelerometer readings, and geolocation coordinates. The data may also include timestamps and metadata for alignment and validation purposes. For instance, each device's timestamped audio data is preprocessed for time-synchronization to ensure compatibility with TDOA calculations.

At step 1004, the system evaluates the consistency of the collected data across participating devices. In an embodiment, this involves cross-correlation analysis between time-synchronized sensor streams to assess coherence in detected signals. For example, audio signals from multiple devices may be analyzed for matching frequency patterns or waveforms. Any discrepancies, such as outliers or mismatched timestamps, are flagged for exclusion or correction.

At step 1006, the system determines whether the number of participating devices meets predefined sufficiency thresholds. This threshold is configurable and depends on factors such as the desired geolocation accuracy, environmental conditions, and the specific geolocation technique employed. For example, TDOA-based geolocation in two dimensions typically requires at least four devices to resolve ambiguity, while TDOA+AoA geolocation can achieve sufficiency with as few as two devices, provided one device includes a vector sensor. AoA-only geolocation may require two or three devices, depending on the geometry and angle measurement uncertainty. If the threshold is not met, the process loops back to step 1002 to allow additional devices to join the SEGNet and contribute data.

At step 1008, the system evaluates the quality and reliability of the collected data. This may include analyzing signal-to-noise ratios (SNR), evaluating timestamp precision, and assessing sensor performance metrics. For example, devices with high SNRs and minimal latency may be prioritized, while those with degraded sensors or low battery levels may be deprioritized or excluded.

At step 1010, a decision point is reached to determine whether the data sufficiency criteria are met. If the criteria are not met (“No” path), the system may either return to step 1002 to collect additional data or adjust operational parameters, such as lowering detection thresholds or recalibrating sensors, to proceed with available data. In certain embodiments, fallback methods may involve reporting the GPS geolocation of the device that detected the EOI as a preliminary location estimate when multi-device geolocation methods are unavailable.

If the criteria are met (“Yes” path), the process proceeds to step 1012, where the validated data is provided for geolocation and event classification tasks. This validated dataset is processed by event localization component 221 and other downstream components to generate geolocation estimates and classify the Event of Interest (EOI).

In accordance with various embodiments, the sufficiency validation process described in FIG. 10 ensures that geolocation and event classification tasks are performed with reliable and consistent data, enhancing the overall accuracy and robustness of the SEGNet. For example, by dynamically adjusting sufficiency thresholds and prioritizing high-quality data streams, the system maintains optimal performance even under challenging conditions, such as low device participation or high environmental noise.

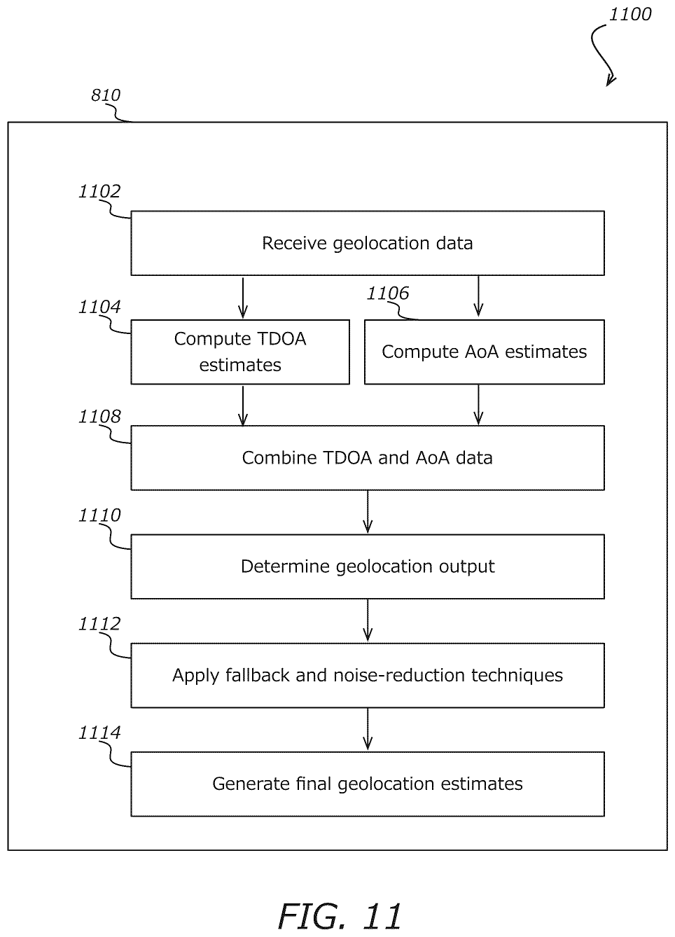

FIG. 11 illustrates an exemplary process 1100 for performing geolocation processing within a Spontaneously Emergent Geolocation Network (SEGNet), corresponding to Step 810 in FIG. 8, in accordance with various embodiments. This process integrates Time Difference of Arrival (TDOA) and/or Angle of Arrival (AoA) techniques, along with hybrid geolocation methods, to estimate the location of an Event of Interest (EOI) with high precision. The steps in this process may be executed by event localization component 221, distributed geolocation processing component 312, and other associated system components. The process may include additional steps, fewer steps, and/or a different sequence of steps without departing from the scope of the invention, as would be apparent to one of ordinary skill in the art.

At step 1102, the system synchronizes sensor data collected from participating SEGNet devices using a GPS-disciplined clock or similar timing mechanism. This synchronization ensures that sensor readings are aligned to a common time reference to assist accurate geolocation processing. For instance, audio signals and accelerometer readings are preprocessed to correct for time offsets and ensure temporal consistency across all devices.

At step 1104, the system performs initial TDOA calculations by analyzing time-stamped sensor data. In an embodiment, cross-correlation techniques are employed to refine crude TDOA estimates derived from timestamp differences between detections. The time offset that maximizes the correlation between time series data from two devices is used to compute the relative arrival times of the event signal. The uncertainty of the TDOA estimate is assessed based on the width of the cross-correlation peak, which informs subsequent geolocation calculations.

Concurrently, at step 1106, the system performs AoA calculations using vector sensors, such as 3-axis accelerometers, in combination with scalar sensors, such as microphones or barometers. This process involves determining the correlation between the audio signal and the accelerometer data along each axis. The accelerometer's z-axis is rotated to align with the direction of the signal source using coordinate transformations, and the resulting angles are converted into an East-North-Up (ENU) coordinate system. These angles, including azimuth and polar angles, provide directional information about the EOI relative to the participating devices.

At step 1108, the TDOA and AoA estimates from steps 1104 and 1106 are fused to enhance geolocation accuracy. In an embodiment, this fusion involves assigning weights to the TDOA and AoA estimates based on their respective uncertainties and combining them to generate a unified geolocation estimate. For instance, if TDOA estimates have a higher confidence level due to clear time-series correlations, they may be weighted more heavily than AoA estimates, and vice versa.

At step 1110, the system applies optimization techniques to determine the EOI's geolocation. These techniques may include least squares, weighted least squares, or Maximum Likelihood Estimation (MLE) to solve the system of equations derived from TDOA and AoA measurements. For example, MLE may be used to minimize the error between predicted and observed signal arrival times and directions, resulting in a geolocation estimate with high accuracy.

At step 1112, the system addresses practical challenges that may arise during geolocation processing. In scenarios where GPS signals are obstructed or unavailable, fallback methods such as Wi-Fi triangulation or cellular tower proximity are employed. Additionally, noise-reduction techniques, such as adaptive filtering or Kalman filtering, may be applied to mitigate the impact of environmental interference or device-specific anomalies.

At step 1114, the geolocation estimate is generated and made available for downstream components, such as notification system interface 306 or external system interface 308, for further processing and dissemination. The geolocation output may also be stored in geolocation data store 334 for future analysis or integration into machine learning models to improve geolocation algorithms.

In accordance with various embodiments, the geolocation processing described in FIG. 11 ensures accurate and reliable estimation of EOIs' locations, even under challenging conditions such as noisy environments or limited device participation. By integrating TDOA, AoA, and hybrid methods, the system provides robust geolocation capabilities that enhance the overall performance of the SEGNet.

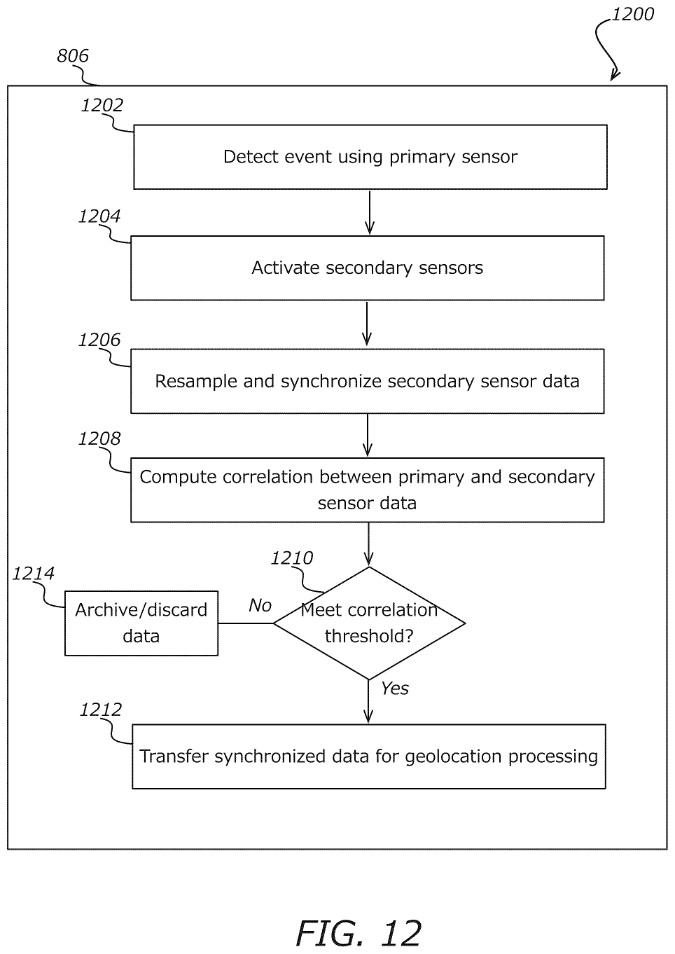

FIG. 12 illustrates an exemplary process 1200 for multi-sensor detection and data fusion within a Spontaneously Emergent Geolocation Network (SEGNet), corresponding to Step 806 in FIG. 8, in accordance with various embodiments. This process describes the detection and correlation methods employed to trigger SEGNet formation and initiate geolocation processing. The steps in this process may be executed by components such as sensor fusion component 210 and sensor data aggregator 218. The process may include additional steps, fewer steps, and/or a different order of steps, without departing from the scope of the invention, as would be apparent to one of ordinary skill in the art.

At step 1202, a primary sensor on a participating device detects a potential Event of Interest (EOI). The primary sensor, such as a microphone for audio-based events, applies a detection method, such as a Constant False Alarm Rate (CFAR) algorithm, to identify patterns in the sensor data consistent with an EOI, such as a gunshot or explosion. The detection threshold is configured to minimize false alarms while maintaining sensitivity to true events. If no detection occurs, the data is discarded or archived for later use.

At step 1204, upon detection by the primary sensor, the system activates secondary sensors on the same device or across other participating devices within the SEGNet. These secondary sensors, such as accelerometers, gyroscopes, or barometers, collect data relevant to the detected EOI. For instance, accelerometers may capture shockwave-like motion, while barometers may detect rapid pressure changes indicative of an explosion.

At step 1206, the data from secondary sensors is resampled and synchronized with the primary sensor's data. This synchronization involves aligning the secondary sensor data to the sampling rate and timestamps of the primary sensor using time-synchronization techniques, such as GPS-disciplined clocks or dynamic time warping (DTW). This alignment ensures that all sensor data streams are temporally consistent, enabling accurate cross-sensor analysis.

At step 1208, the system computes the correlation between the primary sensor's data and the synchronized data from each secondary sensor. For instance, audio signals from the primary sensor may be correlated with accelerometer data transformed to its principal component using covariance analysis. This transformation aligns the 3-axis accelerometer data to a single axis, facilitating direct correlation with the audio data. The computed correlation values are evaluated against predefined thresholds to determine whether the detected signals are consistent across multiple sensors.

At step 1210, a decision is made based on the computed correlation values. If the correlation values exceed the thresholds, the process proceeds to initialize the SEGNet for geolocation processing at step 1212. This initialization involves transmitting the correlated sensor data to SEGNet components, such as event localization component 221, for further analysis and geolocation computations. Conversely, if the thresholds are not met, the data is discarded or archived 1214 for training purposes, and the SEGNet formation is terminated.

In an embodiment, when sensors operate in different data domains (e.g., audio and accelerometer data), preprocessing steps transform the data into a common representation to enable correlation. For example, shockwave events (e.g., explosions or gunfire) may involve rotating accelerometer data to align the z-axis with the direction of maximum variance, ensuring compatibility with the audio data for correlation analysis.

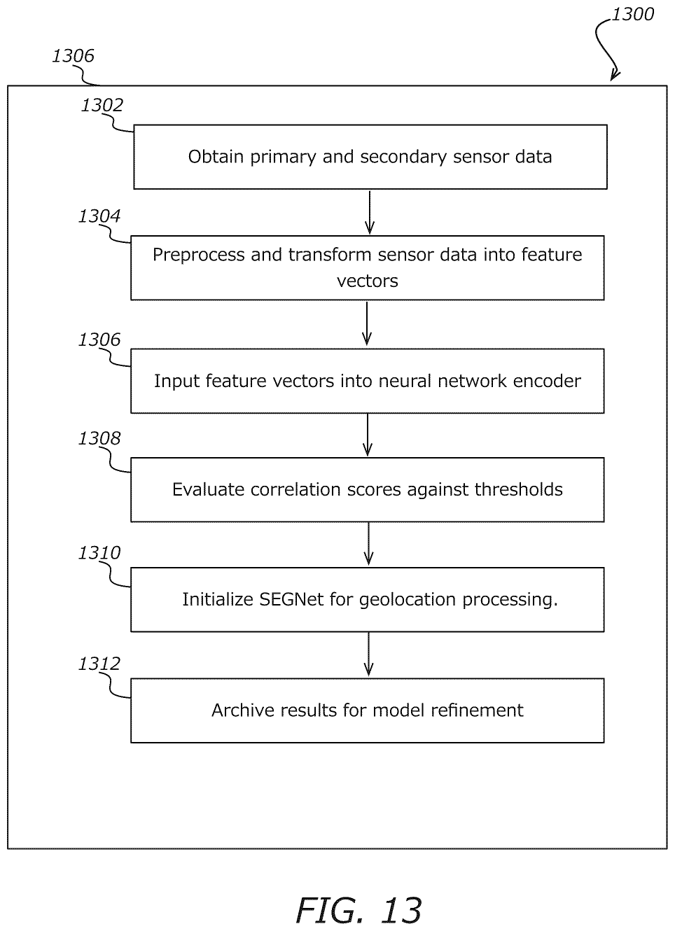

FIG. 13 illustrates an exemplary process 1300 for multi-sensor detection and data fusion using a neural network encoder within a Spontaneously Emergent Geolocation Network (SEGNet), corresponding to Step 806 in FIG. 8, in accordance with various embodiments. This process utilizes machine learning techniques, specifically a neural network encoder, to dynamically compute correlations between sensor data from multiple devices, enabling accurate detection and geolocation of Events of Interest (EOIs). The steps in this process may be executed by components such as sensor fusion component 210, machine learning system 136, and sensor data aggregator 218. The process may include additional steps, fewer steps, and/or a different sequence of steps without departing from the scope of the invention, as would be apparent to one of ordinary skill in the art.

At step 1302, sensor data is obtained from primary and secondary sensors across participating SEGNet devices. The primary sensor, such as a microphone, detects potential EOIs based on predefined thresholds, while secondary sensors, such as accelerometers or barometers, capture complementary data associated with the detected event. For instance, the primary sensor may capture audio signals, while the secondary sensors record motion or pressure changes indicative of shockwave events.

At step 1304, the sensor data streams are preprocessed and transformed into feature vectors suitable for neural network encoding. This preprocessing includes steps such as resampling, synchronization, and dimensionality reduction. For example, accelerometer data may undergo principal component analysis (PCA) to identify the dominant axis of motion, while audio data is converted into a spectrogram or other time-frequency representation. The resulting feature vectors are then normalized to ensure compatibility across sensor modalities.

At step 1306, the feature vectors are input into a neural network encoder trained to analyze and correlate multi-sensor data. The encoder is configured to maximize the correlation between the feature vectors of primary and secondary sensors when an EOI is present and to minimize correlation otherwise. In an embodiment, the encoder architecture includes convolutional layers for extracting spatial and temporal patterns from the feature vectors, followed by fully connected layers for computing similarity metrics. The encoder generates correlation scores representing the degree of agreement between the primary and secondary sensor data streams.

At step 1308, the correlation scores are evaluated against predefined thresholds to determine whether the detected event meets the criteria for SEGNet formation and geolocation processing. For example, if the correlation scores exceed the thresholds, the system identifies the event as a valid EOI, triggering further processing. Conversely, if the correlation scores fall below the thresholds, the event is flagged as a false alarm, and the data is either discarded or archived for model training and refinement.

At step 1310, for events that meet the correlation thresholds, the system initializes the SEGNet and transmits the correlated sensor data to geolocation components, such as event localization component 221. This data is subsequently processed to compute precise geolocation estimates using methods such as Time Difference of Arrival (TDOA) and/or Angle of Arrival (AoA).

At step 1312, the correlation results and associated data may be archived in machine learning system 136 for model refinement. By incorporating the correlation scores and their associated events into the training dataset, the neural network encoder is periodically retrained to adapt to new environmental conditions, sensor configurations, or event types, enhancing its performance over time.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card. For embodiments utilizing SEGNet, the electronic device is operable to collect, synchronize, and preprocess multi-sensor data for collaborative event detection and geolocation.

Software/hardware hybrid implementations of at least some of the embodiments disclosed herein may be implemented on a programmable network-resident machine or mobile edge device, (which should be understood to include intermittently connected network-aware machines) selectively activated or reconfigured by a computer program stored in memory. Such network devices may have multiple network interfaces that may be configured or designed to utilize different types of network communication protocols. For example, the mobile devices within a SEGNet may communicate over Bluetooth, Wi-Fi, 5G, or other appropriate communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as, for example, an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

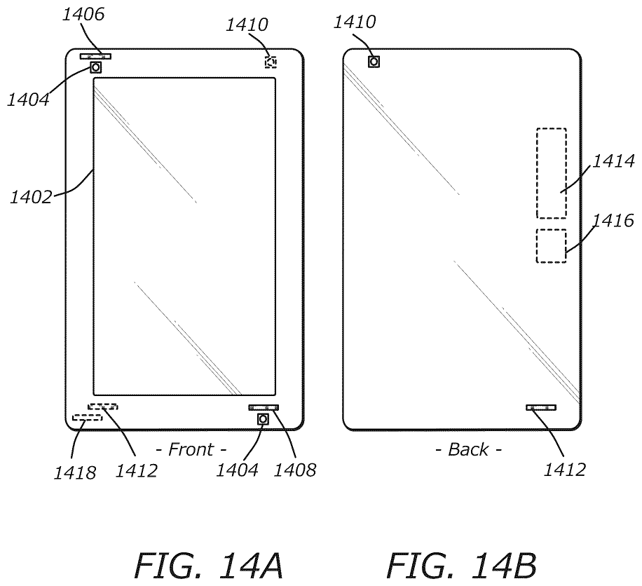

Referring now to FIG. 14A and FIG. 14B, FIG. 14A illustrates a front view of an electronic device and FIG. 14B illustrates a back view of the example electronic computing device that can be used in accordance with various embodiments. Although a portable computing device (e.g., a smartphone, an electronic book reader, or tablet computer) is shown, it should be understood that any device capable of receiving and processing input can be used in accordance with various embodiments discussed herein, where the devices can include, for example, head-mounted displays, notebook computers, personal data assistants, cellular phones, smart glasses or goggles, smartwatch, wearables, unmanned vehicles such as drones or other autonomous vehicles, and portable media players, among others.

In this example, the computing device has a display screen 1402 (e.g., an LCD element) operable to display information or image content to one or more users or viewers of the device. In SEGNet implementations, the display screen may provide real-time feedback for detected EOIs, geolocation estimates, or system notifications to the user. The display screen of some embodiments displays information to the viewers facing the display screen (e.g., on the same side of the computing device as the display screen). The computing device in this example can include one or more imaging elements, in this example including two image capture elements 1404 on the front of the device and at least one image capture element 1410 on the back of the device. It should be understood, however, that image capture elements could also, or alternatively, be placed on the sides or corners of the device, and that there can be any appropriate number of capture elements of similar or different types. Each image capture element 1404 and 1410 may be, for example, a camera, a charge-coupled device (CCD), a motion detection sensor, or an infrared sensor, or other image capturing technology.

The device can use the images (e.g., still or video) captured from the imaging elements 1404 and 1410 to generate a three-dimensional simulation of the surrounding environment (e.g., a virtual reality of the surrounding environment for display on the display element of the device). Further, the device can utilize outputs from at least one of the image capture elements 1404 and 1410 to assist in determining the location and/or orientation of a user and in recognizing nearby persons, objects, or locations. For example, participating SEGNet devices may use captured image data to enhance geolocation accuracy, validate EOIs, or synchronize sensor data across the network. If the user is holding the device, the captured image information can be analyzed (e.g., using mapping information about a particular area) to determine the approximate location and/or orientation of the user. The captured image information may also be analyzed to recognize nearby persons, objects, or locations (e.g., by matching parameters or elements from the mapping information).

The computing device can also include at least one microphone or other audio capture elements capable of capturing audio data, such as words spoken by a user of the device, music being hummed by a person near the device, or audio being generated by a nearby speaker or other such component, although audio elements are not required in at least some devices. In this example, there are three microphones, one microphone 1408 on the front side, one microphone 1412 on the back, and one microphone 1406 on or near the top or side of the device. For SEGNet, microphones may serve as primary sensors for detecting audio-based EOIs, such as gunshots or explosions. In some devices, there may be only one microphone, while in other devices, there might be at least one microphone on each side and/or corner of the device, or in other appropriate locations.

The device in this example also includes one or more orientation- or position-determining elements 1418 operable to provide information such as position data, direction data, motion data, or orientation data for the device. These elements can include, for example, accelerometers, inertial sensors, electronic gyroscopes, and electronic compasses. Such sensors may serve as secondary inputs in SEGNet, contributing data for geolocation processing and EOI validation.

The example device also includes at least one communication mechanism 1414, such as may include at least one wired or wireless component operable to communicate with one or more electronic devices. The device also includes a power system 1416, such as may include a battery operable to be recharged through conventional plug-in approaches, or through other approaches such as capacitive charging through proximity with a power mat or other such device. Various other elements and/or combinations are possible as well within the scope of various embodiments.

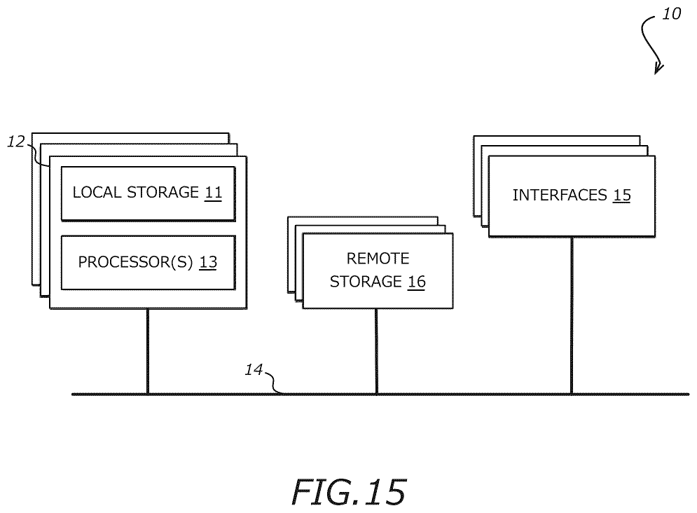

Referring now to FIG. 15, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 15 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

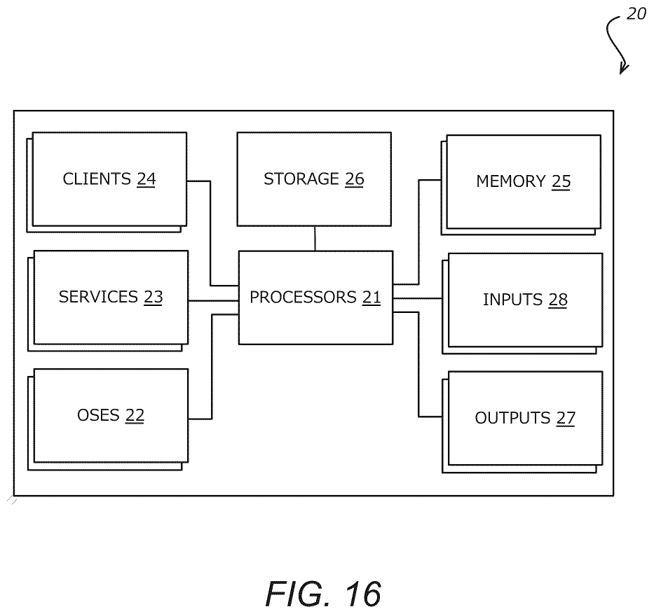

In some embodiments, systems may be implemented on a standalone computing system. Referring now to FIG. 16, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 15). Examples of storage devices 26 include flash memory, magnetic hard drive, CD-ROM, and/or the like.

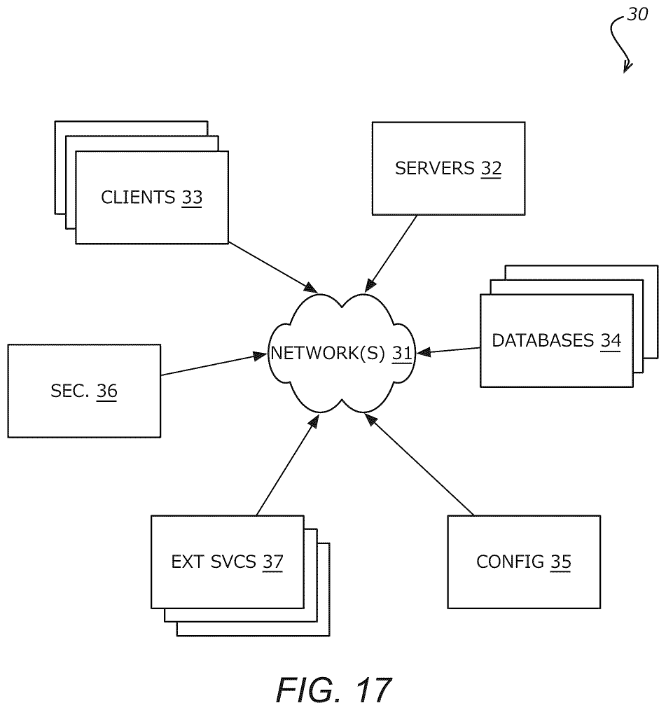

In some embodiments, systems may be implemented on a distributed computing network, such as one having any number of clients and/or servers. Referring now to FIG. 17, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 16. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Network 31 may be implemented using any known network protocols, including for example wired and/or wireless protocols.

In addition, in some embodiments, servers 32 may call external services 37 when needed to obtain additional information, or to refer to additional data concerning a particular call.

Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

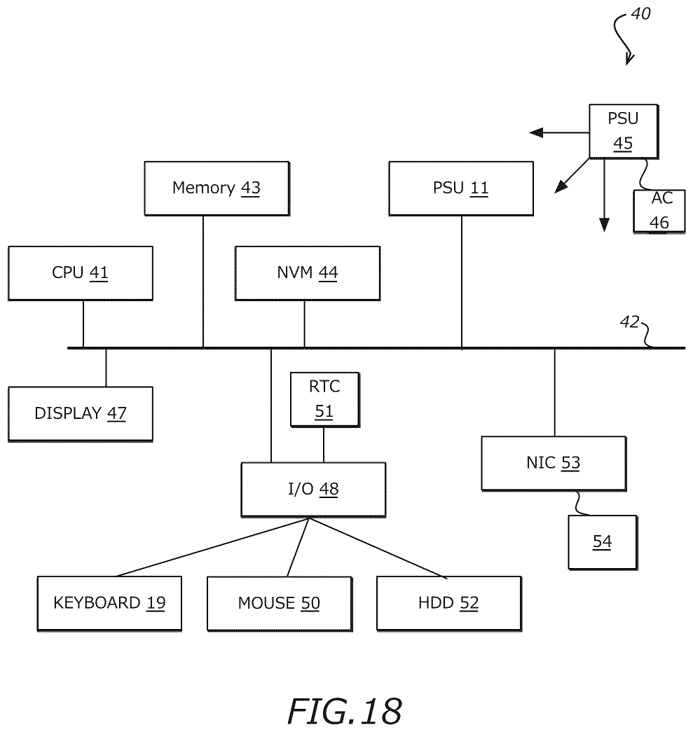

FIG. 18 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

### Additional Hardware Architecture Considerations

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Additional Considerations

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for facilitating database queries through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computing system for event detection and localization, comprising:
a computing device processor; and
a memory device including instructions that, when executed by the computing device processor, enables the computing system to:
obtain sensor data from a plurality of devices, each device including at least one sensor;
from at least a subset of the plurality of devices, detect a potential event using a trained model applied to the sensor data, the trained model being operable to identify events based on predefined criteria;
dynamically form a network of devices from the subset of the plurality of devices based on a detection of the potential event;
synchronize and correlate the sensor data across the network of devices to validate an occurrence of the potential event;
apply geolocation techniques to correlated data to determine a location of the potential event; and
generate an event detection and geolocation result.

2. The computing system of claim 1, wherein the plurality of devices comprises at least one of smartphones, wearables, drones, and autonomous vehicles.

3. The computing system of claim 1, wherein the trained model is a machine learning model trained on historical event data associated with events of interest, and wherein events of interest include at least auditory, environmental, or physical phenomena.

4. The computing system of claim 1, wherein the trained model is operable to identify events using multimodal data inputs, including audio data, accelerometer data, and barometric pressure data.

5. The computing system of claim 1, wherein dynamically forming the network includes prioritizing devices based on at least one of proximity to the potential event, resource availability, and signal strength.

6. The computing system of claim 1, wherein geolocation techniques include at least one of Time Difference of Arrival (TDOA) or Angle of Arrival (AoA).

7. The computing system of claim 1, wherein synchronizing sensor data includes time-aligning sensor outputs using at least one synchronization mechanism.

8. The computing system of claim 1, wherein dynamically forming the network includes selecting devices based on compatibility with event-specific data processing requirements.

9. The computing system of claim 1, wherein the event detection and geolocation result includes at least one of event type, timestamp, geolocation coordinates, and event confidence level.

10. The computing system of claim 1, wherein correlating sensor data includes dynamically adjusting correlation thresholds based on environmental conditions, including at least one of noise levels, signal interference, or device density.

11. A computer-implemented method for event detection and localization, comprising:
obtaining sensor data from a plurality of devices, each device including at least one sensor;
detecting a potential event from at least a subset of the plurality of devices by applying a trained model to the sensor data, the trained model being operable to identify events based on predefined criteria;
dynamically forming a network of devices from the subset of the plurality of devices based on a detection of the potential event;
synchronizing and correlating the sensor data across the network of devices to validate an occurrence of the potential event;
applying geolocation techniques to correlated data to determine a location of the potential event; and
generating an event detection and geolocation result.

12. The computer-implemented method of claim 11, further comprising:
synchronizing sensor data across the network of devices using at least one synchronization mechanism, the synchronization mechanism including GPS-disciplined clocks or dynamic time warping.

13. The computer-implemented method of claim 11, wherein detecting the potential event comprises applying multimodal data inputs to a trained model, the multimodal data inputs including at least audio signals, accelerometer readings, and barometric pressure variations.

14. The computer-implemented method of claim 11, further comprising:
iteratively refining geolocation results by integrating additional sensor data from dynamically added devices to the network after an initial geolocation estimate.

15. The computer-implemented method of claim 11, wherein applying geolocation techniques includes:
analyzing time-stamped audio data to compute relative time delays across devices using Time Difference of Arrival (TDOA); and
refining TDOA estimates using cross-correlation techniques to enhance alignment of signal waveforms.

16. The computer-implemented method of claim 11, wherein applying geolocation techniques includes:
determining directional information from vector sensors using coordinate transformations; and
converting directional estimates into azimuth and elevation angles relative to a reference coordinate system.

17. The computer-implemented method of claim 11, wherein validating the occurrence of the potential event comprises:
computing cross-correlation between sensor data streams from multiple devices to identify correlation values identifying consistent patterns; and
evaluating the correlation values against predefined thresholds indicative of an event.

18. A non-transitory computer-readable storage medium storing instructions that, when executed by at least one processor of a computing system, causes the computing system to:
obtain sensor data from a plurality of devices, each device including at least one sensor;
from at least a subset of the plurality of devices, detect a potential event using a trained model applied to the sensor data, the trained model being operable to identify events based on predefined criteria;
dynamically form a network of devices from the subset of the plurality of devices based on a detection of the potential event;
synchronize and correlate the sensor data across the network of devices to validate an occurrence of the potential event;
apply geolocation techniques to correlated data to determine a location of the event; and
generate an event detection and geolocation result.

19. The non-transitory computer-readable storage medium of claim 18, wherein the instructions are configured to prioritize devices for network formation based on proximity to the potential event, available resources, or compatibility with event-specific data processing requirements.

20. The non-transitory computer-readable storage medium of claim 18, wherein the instructions are configured to share geolocation processing tasks among devices in the network, reducing resource consumption on individual devices.
